(19) United States
(12) Patent Application Publication
(10) Pub. No.: US 2022/0049133 A1
(43) Pub. Date: Feb. 17, 2022

(54) ADHESIVE SHEET

(71) Applicant: DIC Corporation, Tokyo (JP)

(72) Inventors: Daisuke Watanabe, Kitaadachi-gun (JP); Takamine Sugiura, Kitaadachi-gun (JP)

(73) Assignee: DIC Corporation, Tokyo (JP)

(21) Appl. No.: 17/311,807

(22) PCT Filed: Aug. 29, 2019
(86) PCT No.: PCT/JP2019/033872

§ 371 Date: Jun. 8, 2021

(30) Foreign Application Priority Data
Dec. 13, 2018 (JP) 2018-233488

(51) Int. Cl. C09J 7/38; C09J 7/24; C09J 7/25; C09J 11/04

(52) U.S. Cl. CPC C09J 7/385; C09J 7/24; C09J 7/25; C09J 11/04; C09J 2301/414; C09J 2475/006; C09J 2433/00; C09J 2301/408; C09J 2453/006

(57) ABSTRACT

The adhesive sheet can be easily peeled off by stretching even if the direction of the stretching is the perpendicular direction with respect to an attached surface of an attached object, and is less likely to break even when a substrate of the adhesive sheet is thin, and is excellent in impact resistance, shear adhesive strength, and cleavage adhesive strength. The present invention relates to an adhesive sheet including an adhesive layer and a substrate layer. The adhesive layer contains filler particles and an adhesive resin. The content of the filler particles in the adhesive layer is 10 parts by weight to 90 parts by weight relative to 100 parts by weight of the adhesive resin. The volume ratio of the filler particles to the adhesive layer is 4% to 40%. The adhesive sheet has a stress at 25% elongation of 0.15 Mpa to 82 Mpa.

### TECHNICAL FIELD

The present invention relates to an adhesive sheet.

### BACKGROUND ART

Adhesive sheets (also referred to as “adhesive tapes”) are highly workable bonding means with high adhesion reliability and thus have been extensively used in, for example, fixation of parts constituting electronic appliances. Specifically, the adhesive tapes have been used in, for example, part fixation applications in various industrial fields, e.g., fixation of metal sheets constituting relatively large electronic appliances such as flat-screen televisions, household electrical appliances, and QA appliances, fixation of exterior parts to housings, and fixation of exterior parts or rigid parts such as batteries to relatively small electronic appliances such as portable electronic terminals, cameras, and personal computers; applications of temporary fixation of such parts; and applications as labels displaying product information.

In recent years, in the above various industrial fields, recyclable or reusable parts used in products have often been disassembled after use and recycled or reused for the purpose of, for example, resource saving from the viewpoint of global environmental conservation. When an adhesive tape is used in this case, the adhesive tape attached to parts needs to be peeled off, and since the adhesive tape typically has a high adhesive strength and is bonded to many places in a product, the operation for peeling them off involves considerable labor. Thus, there has been a need for adhesive tapes that are relatively easily peelable and removable when recycled or reused as described above.

As an adhesive tape that is easily peelable and removable, an adhesive tape has been proposed that includes an adhesive portion and a tab portion and can be peeled off adherends attached to both surfaces of the adhesive portion in such a manner that the tab portion is pinched and stretched in a direction substantially parallel to the bonded surfaces (see PTL 1). However, in the case of a small electronic appliance as described above, the space between members in the electronic appliance is narrow, and thus there is a problem in that it is difficult to peel off an adhesive tape attached in the space by stretching in a direction parallel to bonded surfaces.

On the other hand, an adhesive tape that can be removed again by being stretched in the 30° direction with respect to a bonded surface has also been proposed (see PTL 2). However, it is desired that the adhesive tape attached in a narrow space be peeled off by stretching at a greater angle.

When the thickness of a substrate of an adhesive tape is decreased in order to ensure the flexibility of the adhesive tape, there is a problem in that the adhesive tape is readily broken when peeled off by stretching. If the flexibility of the adhesive tape is low, there is a problem in that the adhesive tape may be peeled off upon an impact caused, for example, when a product, particularly, a small electronic appliance, in which the adhesive tape is used is dropped during use. To overcome these problems, an adhesive tape that does not suffer damage such as breakage during pulling operation and also has impact resistance has been proposed (see PTL 3). However, this proposed adhesive tape has a problem in that it cannot be peeled off by stretching at an angle.

Thus, there is a strong need to provide an adhesive tape that can be peeled off by stretching not only in a parallel direction (horizontal direction) with respect to an attached surface of an attached object but can also be easily peeled off by stretching even if the direction of the stretching is a vertical direction, that is less likely to break even when a substrate of the adhesive tape is thin, and that is excellent in impact resistance, shear adhesive strength, and cleavage adhesive strength.

### CITATION LIST

### Patent Literature

PTL 1: Japanese Unexamined Patent Application Publication No. 2015-124289

PTL 2: Japanese Unexamined Patent Application Publication (Translation of PCT Application) No. 2016-504449

PTL 3: Japanese Unexamined Patent Application Publication No. 2015-124289

### SUMMARY OF INVENTION

### Technical Problem

The present invention aims to solve the above various problems of the related art and achieve the following object. Thus, it is an object of the present invention to provide an adhesive sheet that can be easily peeled off by stretching even if the direction of the stretching is the perpendicular direction with respect to an attached surface of an attached object, that is less likely to break even when a substrate of the adhesive sheet is thin, and that is excellent in impact resistance, shear adhesive strength, and cleavage adhesive strength.

### Solution to Problem

The means of solving the above problems are as described below.

Thus, an adhesive sheet includes an adhesive layer and a substrate layer. The adhesive layer contains filler particles and an adhesive resin. The content of the filler particles in the adhesive layer is 10 parts by weight to 90 parts by weight relative to 100 parts by weight of the adhesive resin. The volume ratio of the filler particles to the adhesive layer is 4% to 40%. The adhesive sheet has a stress at 25% elongation of 0.15 Mpa to 82 Mpa.

### Advantageous Effects of Invention

According to the present invention, the above various problems of the related art can be solved to achieve the above object, and an adhesive sheet that can be easily peeled off by stretching even if the direction of the stretching is the perpendicular direction with respect to an attached surface of an attached object, that is less likely to break even when a substrate of the adhesive sheet is thin, and that is excellent in impact resistance, shear adhesive strength, and cleavage adhesive strength can be provided.

### BRIEF DESCRIPTION OF DRAWINGS

FIG. 1 schematically illustrates how adhesive sheets 1 are attached to an acrylic plate 2 in evaluating impact resistance in EXAMPLES.

FIG. 2 schematically illustrates a test piece prepared in evaluating impact resistance in EXAMPLES.

FIG. 3 schematically illustrates how the test piece is placed on a U-shaped measurement stage in evaluating impact resistance in EXAMPLES.

### DESCRIPTION OF EMBODIMENTS

### (Adhesive Sheet)

An adhesive sheet of the present invention at least includes an adhesive layer and a substrate layer and optionally further includes other layers.

### <Adhesive Layer>

The adhesive layer at least contains filler particles and an adhesive resin and optionally further contains other components.

These components constituting the adhesive layer are not particularly limited as long as they are contained in the adhesive layer, but are preferably contained in an adhesive composition.

### <<Adhesive Composition>>

The adhesive composition at least contains the filler particles and the adhesive resin and optionally further contains other components.

### —Filler Particles—

Due to the presence of the filler particles in the adhesive layer, the filler particles are exposed from the adhesive layer when the adhesive sheet is stretched, which decreases the area of bonding between the adhesive layer and an adherend, and thus the adhesive sheet can be easily peeled off by stretching even if the direction of the stretching is the perpendicular direction (also referred to as the “90° direction”) with respect to an attached surface (hereinafter also referred to as a “bonded surface”) of an attached object (hereinafter also referred to as an “adherend”).

The type of the filler particles is not particularly limited and may be appropriately selected as long as the advantageous effects of the present invention are not impaired. Inorganic filler particles may be used, or organic filler particles may be used. These may be used alone or in combination of two or more.

Specific examples of the inorganic filler particles include aluminum hydroxide, magnesium hydroxide, aluminum oxide, silicon oxide, magnesium oxide, zinc oxide, titanium oxide, zirconium oxide, iron oxide, silicon carbide, boron nitride, aluminum nitride, titanium nitride, silicon nitride, titanium boride, carbon, nickel, copper, aluminum, titanium, gold, silver, zirconium hydroxide, basic magnesium carbonate, dolomite, hydrotalcite, calcium hydroxide, barium hydroxide, tin oxide, hydrated tin oxide, borax, zinc borate, zinc metaborate, barium metaborate, zinc carbonate, magnesium-calcium carbonate, calcium carbonate, barium carbonate, molybdenum oxide, antimony oxide, red phosphorus, mica, clay, kaolin, talc, zeolite, wollastonite, smectite, silica (e.g., quartz, fumed silica, precipitated silica, silicic anhydride, fused silica, crystalline silica, and ultrafine amorphous silica), potassium titanate, magnesium sulfate, sepiolite, zonolite, aluminum borate, barium sulfate, barium titanate, zirconia oxide, cerium, tin, indium, carbon, sulfur, terium, cobalt, molybdenum, strontium, chromium, barium, lead, tin oxide, indium oxide, diamond, magnesium, platinum, zinc, manganese, and stainless steel. Of these, for example, aluminum hydroxide and nickel are preferred.

To improve the dispersibility in the adhesive resin, the inorganic filler may be subjected to surface treatment such as silane coupling treatment or stearic acid treatment.

Specific examples of the organic filler particles include polystyrene fillers, benzoguanamine fillers, polyethylene fillers, polypropylene fillers, silicone fillers, urea-formalin fillers, styrene/methacrylic acid copolymers, fluorine fillers, acrylic fillers, polycarbonate fillers, polyurethane fillers, polyamide fillers, epoxy resin fillers, and thermosetting resin hollow fillers.

The shape of the filler particles may be appropriately selected depending on the purpose without any limitation, and may be a regular shape or an irregular shape. Specifically, the shape of the filler particles may be, for example, polygonal, cubic, oval, spherical, needle-like, plate-like, or scaly. The filler particles of these shapes may be used alone or in combination of two or more. Aggregates of the filler particles of these shapes may also be used. Of these, the shape of the filler particles is preferably oval, spherical, or polygonal. If the shape of the filler particles is, for example, oval, spherical, or polygonal, the adhesive layer slips well on the adherend when the adhesive sheet is stretched, and the adhesive sheet can be easily peeled off by stretching even if the direction of the stretching is the 90° direction with respect to the attached surface of the adherend.

The particle size distribution (D₉₀/D₁₀) of the filler particles may be appropriately selected depending on the purpose without any limitation, and is preferably 2.5 to 20. In terms of impact resistance, it is more preferably 2.5 to 15, still more preferably 2.5 to 5. When the particle size distribution (D₉₀/D₁₀) of the filler particles is in the above preferred range, the adhesive sheet can be easily peeled off by stretching even if the direction of the stretching is the 90° direction with respect to an attached surface of an adherend, is less likely to break even when the substrate of the adhesive sheet is thin, and is excellent in impact resistance, shear adhesive strength, and cleavage adhesive strength. However, if the particle size distribution (D₉₀/D₁₀) of the filler particles is less than 2.5, the stretching peelability of the adhesive sheet in the case where the direction of the stretching is the 90° direction with respect to an attached surface of an adherend may be impaired, and if the particle size distribution (D₉₀/D₁₀) of the filler particles is more than 20, adhesive properties such as impact resistance, shear adhesive strength, and cleavage adhesive strength may be impaired.

The particle size distribution (D₉₀/D₁₀) of the filler particles can be determined by, for example, measuring the particle size of the filler particles with a measuring machine (Microtrac) using a laser diffraction scattering method and converting the measurements into a particle size distribution.

The volume-average particle size of the filler particles may be appropriately selected depending on the purpose without any limitation, and is preferably 3 μm to 25 μm, more preferably 5 μm to 20 μm, still more preferably 5 μm to 14 μm. When the volume-average particle size of the filler particles is in the above preferred range, the adhesive sheet can be easily peeled off by stretching even if the direction of the stretching is the 90° direction with respect to an attached surface of an adherend, is less likely to break even when the substrate of the adhesive sheet is thin, and is excellent in impact resistance, shear adhesive strength, and cleavage adhesive strength. However, if the volume-average particle size of the filler particles is less than 3 μm, the adhesive sheet may be less easily peeled off by stretching when the direction of the stretching is the 90° direction with respect to an attached surface of an adherend, and if the volume-average particle size of the filler particles is more than 25 μm, adhesive properties such as impact resistance, shear adhesive strength, and cleavage adhesive strength may be impaired.

The volume-average particle size of the filler particles can be measured, for example, with a measuring machine (Microtrac) using a laser diffraction scattering method.

The ratio between the volume-average particle size of the filler particles and an average thickness described below of the adhesive layer may be appropriately selected depending on the purpose without any limitation, and the ratio of the volume-average particle size of the filler particles to the average thickness of the adhesive layer, as expressed by [volume-average particle size of filler particles/average thickness of adhesive layer], is preferably 5/100 or more, more preferably 5/100 to 95/100, still more preferably 10/100 to 75/100, particularly preferably 20/100 to 60/100. When the ratio is in the above preferred range, the adhesive sheet can be easily peeled off by stretching even if the direction of the stretching is the 90° direction with respect to an attached surface of an adherend and is less likely to break even when the substrate of the adhesive sheet is thin. When the ratio is in the above particularly preferred range, it is advantageous in that the adhesive sheet can be easily peeled off by stretching even if the direction of the stretching is the 90° direction with respect to an attached surface of an adherend, is less likely to break even when the substrate of the adhesive sheet is thin, and is more excellent in adhesive properties such as impact resistance, shear adhesive strength, and cleavage adhesive strength. However, if the ratio is less than 5/100, the stretching peelability of the adhesive sheet in the case where the direction of the stretching is the 90° direction with respect to an attached surface of an adherend may be impaired, and if the ratio is more than 95/100, adhesive properties such as impact resistance, shear adhesive strength, and cleavage adhesive strength may be impaired.

The content of the filler particles in the adhesive layer is 10 parts by weight to 90 parts by weight relative to 100 parts by weight of the adhesive resin, but is preferably 15 parts by mass to 50 parts by mass, more preferably 20 parts by mass to 40 parts by mass. If the content of the filler particles relative to 100 parts by weight of the adhesive resin is less than 10 parts by weight, the adhesive sheet cannot be peeled off by stretching when the direction of the stretching is the 90° direction with respect to an attached surface of an adherend, and breakage of the adhesive sheet occurs, so that the adhesive sheet is not stretched and cannot be removed. If the content of the filler particles relative to 100 parts by weight of the adhesive resin is more than 90 parts by weight, the adhesive sheet is not stretched, the adhesive composition is left behind on the adherend, the impact resistance is reduced, and the shear adhesive strength and the cleavage adhesive strength may be weakened. However, when the content of the filler particles relative to 100 parts by weight of the adhesive resin is 10 parts by weight to 90 parts by weight, the adhesive sheet can be easily peeled off by stretching even if the direction of the stretching is the 90° direction with respect to an attached surface of an adherend, is less likely to break even when the substrate of the adhesive sheet is thin, and is excellent in impact resistance, shear adhesive strength, and cleavage adhesive strength.

The content of the filler particles in the adhesive layer can be adjusted as appropriate in preparing the adhesive composition.

The volume ratio of the filler particles with respect to the total volume of the adhesive layer is 4% to 40%, but is preferably 5% to 30%, more preferably 5% to 20%, still more preferably 5% to 15%.

If the volume ratio of the filler particles is less than 4%, the adhesive sheet cannot be peeled off by stretching when the direction of the stretching is the 90° direction with respect to an attached surface of an adherend, and breakage of the adhesive sheet occurs, so that the adhesive sheet is not stretched and cannot be removed. If the volume ratio of the filler particles is more than 40%, the adhesive sheet is not stretched, the adhesive composition is left behind on the adherend, the impact resistance is reduced, and the shear adhesive strength and the cleavage adhesive strength may be weakened. However, when the volume ratio of the filler particles is 4% to 40%, the adhesive sheet can be easily peeled off by stretching even if the direction of the stretching is the 90° direction with respect to an attached surface of an adherend, is less likely to break even when the substrate of the adhesive sheet is thin, and is excellent in impact resistance, shear adhesive strength, and cleavage adhesive strength.

The volume ratio of the filler particles to the adhesive layer can be calculated from formulae (1) to (3) below.

Weight A (g) of adhesive resin*¹/density A (g/cm³) of adhesive resin*¹=volume A (cm³) adhesive resin*¹ formula (1)

Weight B (g) of filler particles/density B (g/cm³) of filler particles=volume B (cm³) of filler particles formula (2)

Volume B (cm³) of filler particles/(volume A (cm³) of adhesive resin*¹+volume B (cm³) of filler particles)×100=volume ratio (%) of filler particles formula (3)

In formulae (1) and (3) above, the adhesive resin represented as *¹ may contain other components described in paragraph [0079] below.

The density is a value measured in accordance with JIS Z 8804.

### —Adhesive Resin—

The adhesive resin is not particularly limited and may be appropriately selected from known adhesive resins. Examples include acrylic adhesive resins, rubber adhesive resins, urethane adhesive resins, and silicone adhesive resins. These may be used alone or in combination of two or more. Of these, the adhesive resin is preferably an acrylic adhesive resin.

### ——Acrylic Adhesive Resin——

The acrylic adhesive resin may be appropriately selected depending on the purpose without any limitation, and may be, for example, a resin containing an acrylic polymer and optionally additives such as a tackifier resin and a crosslinking agent.

The acrylic polymer can be produced by, for example, polymerizing a monomer mixture containing a (meth)acrylic monomer.

The (meth)acrylic monomer may be, for example, an alkyl (meth)acrylate having an alkyl group having 1 to 12 carbon atoms.

Specific examples of the alkyl (meth)acrylate having an alkyl group having 1 to 12 carbon atoms include methyl (meth)acrylate, ethyl (meth)acrylate, n-butyl (meth)acrylate, isobutyl (meth)acrylate, t-butyl (meth)acrylate, n-hexyl (meth)acrylate, n-octyl (meth)acrylate, isooctyl (meth)acrylate, isononyl (meth)acrylate, cyclohexyl (meth)acrylate, and 2-ethylhexyl (meth)acrylate. These may be used alone or in combination of two or more.

The alkyl (meth)acrylate having an alkyl group having 1 to 12 carbon atoms is preferably an alkyl (meth)acrylate having an alkyl group having 4 to 12 carbon atoms, more preferably an alkyl (meth)acrylate having an alkyl group having 4 to 8 carbon atoms, and particularly preferably n-butyl acrylate in order to ensure high adhesion to an adherend.

The amount of the alkyl (meth)acrylate having an alkyl group having 1 to 12 carbon atoms relative to the total amount of monomer used to produce the acrylic polymer is preferably in the range of 80 wt % to 98.5 wt %, more preferably in the range of 90 wt % to 98.5 wt %.

In addition to the monomers described above, a highly polar vinyl monomer can optionally be used as the monomer used to produce the acrylic polymer.

Examples of the highly polar vinyl monomer include (meth)acrylic monomers such as a (meth)acrylic monomer having a hydroxyl group, a (meth)acrylic monomer having a carboxyl group, and a (meth)acrylic monomer having an amide group and sulfonic-group-containing monomers such as vinyl acetate, ethylene-oxide-modified succinic acid acrylate, and 2-acrylamide-2-methylpropane sulphonate. These may be used alone or in combination of two or more.

Specific examples of the vinyl monomer having a hydroxyl group include (meth)acrylic monomers such as 2-hydroxyethyl (meth)acrylate, 2-hydroxypropyl (meth)acrylate, 4-hydroxybutyl (meth)acrylate, and 6-hydroxyhexyl (meth)acrylate.

The vinyl monomer having a hydroxyl group is preferably used when the adhesive resin contains an isocyanate crosslinking agent. Specifically, the vinyl monomer having a hydroxyl group is preferably 2-hydroxyethyl (meth)acrylate, 4-hydroxybutyl (meth)acrylate, or 6-hydroxyhexyl (meth)acrylate.

The amount of the vinyl monomer having a hydroxyl group relative to the total amount of monomer used to produce the acrylic polymer is preferably in the range of 0.01 wt % to 1.0 wt %, more preferably in the range of 0.03 wt % to 0.3 wt %.

Specific examples of the vinyl monomer having a carboxyl group include (meth)acrylic monomers such as acrylic acid, methacrylic acid, itaconic acid, maleic acid, (meth)acrylic acid dimer, crotonic acid, and ethylene-oxide-modified succinic acid acrylate. Of these, acrylic acid is preferred.

Specific examples of the vinyl having an amide group include (meth)acrylic monomers such as N-vinylpyrrolidone, N-vinylcaprolactam, acryloylmorpholine, acrylamide, and N,N-dimethylacrylamide.

The amount of the highly polar vinyl monomer relative to the total amount of monomer used to produce the acrylic polymer is preferably in the range of 1.5 wt % to 20 wt %, more preferably in the range of 1.5 wt % to 10 wt %, and still more preferably in the range of 2 wt % to 8 wt % because an adhesive layer having a good balance of cohesive strength, retentivity, and adhesion can be formed.

The method for producing the acrylic polymer is not particularly limited and may be appropriately selected from known methods depending on the purpose. For example, the above monomer may be polymerized by a polymerization method such as solution polymerization, bulk polymerization, suspension polymerization, or emulsion polymerization. Of these, the acrylic polymer is preferably produced by solution polymerization or bulk polymerization.

In the polymerization, a peroxide thermal polymerization initiator such as benzoyl peroxide or lauroyl peroxide, an azo thermal polymerization initiator such as azobisisobutylnitrile, an acetophenone photopolymerization initiator, a benzoin ether photopolymerization initiator, a benzyl ketal photopolymerization initiator, an acylphosphine oxide photopolymerization initiator, a benzoin photopolymerization initiator, or a benzophenone photopolymerization initiator can be used as required.

The weight-average molecular weight, as measured in terms of standard polystyrene using gel permeation chromatography (GPC), of the acrylic polymer obtained by the above method is preferably 300,000 to 3,000,000, more preferably 500,000 to 2,500,000.

The measurement of the weight-average molecular weight of the acrylic polymer by GPC is performed using a GPC system (HLC-8329GPC, manufactured by Tosoh Corporation) in terms of standard polystyrene under the following measurement conditions.

[Measurement conditions]
Sample concentration: 0.5 wt % (tetrahydrofuran (THF) solution)
Sample injection volume: 100 μL
Eluent: THF
Flow rate: 1.0 mL/min
Measurement temperature: 40° C.
Main column: TSKgel GMHHR-H(20), two columns
Guard column: TSKgel HXL-H
Detector: differential refractometer
Molecular weight of standard polystyrene: 10,000 to 20,000,000 (manufactured by Tosoh Corporation)

The acrylic adhesive resin preferably contains a tackifier resin to improve adhesion to an adherend and surface adhesive strength.

The tackifier resin contained in the acrylic adhesive resin may be appropriately selected depending on the purpose without any limitation, and preferably has a softening point of 30° C. to 180° C., more preferably has a softening point of 70° C. to 140° C. in order to form an adhesive layer having a high adhesive properties. When a (meth)acrylate tackifier resin is used, the glass transition temperature thereof is preferably 30° C. to 200° C., more preferably 50° C. to 160° C.

Specific examples of the tackifier resin contained in the acrylic adhesive resin include rosin tackifier resins, polymerized rosin tackifier resins, polymerized rosin ester tackifier resins, rosin-phenol tackifier resins, stabilized rosin ester tackifier resins, disproportionated rosin ester tackifier resins, hydrogenated rosin ester tackifier resins, terpene tackifier resins, terpene-phenol tackifier resins, petroleum resin tackifier resins, and (meth)acrylate tackifier resins. These may be used alone or in combination of two or more. Of these, the tackifier resin is preferably a polymerized rosin ester tackifier resin, a rosin-phenol tackifier resin, a disproportionated rosin ester tackifier resin, a hydrogenated rosin ester tackifier resin, a terpene phenol resin, or a (meth)acrylate resin.

The amount of the tackifier resin used may be appropriately selected depending on the purpose without any limitation, and is preferably in the range of 5 parts by weight to 65 parts by weight relative to 100 parts by weight of the acrylic polymer, more preferably in the range of 8 parts by weight to 55 parts by weight because adhesion to an adherend is readily ensured.

The acrylic adhesive resin preferably contains a crosslinking agent in order to further improve the cohesive strength of the adhesive layer.

The crosslinking agent may be appropriately selected depending on the purpose without any limitation, and examples include isocyanate crosslinking agents, epoxy crosslinking agents, metal-chelate crosslinking agents, and aziridine crosslinking agents. These may be used alone or in combination of two or more. Of these, the crosslinking agent is preferably of a type that is added after the production of an acrylic polymer to promote crosslinking reaction, and it is more preferable to use an isocyanate crosslinking agent and an epoxy crosslinking agent, which are highly reactive with the acrylic polymer.

Examples of the isocyanate crosslinking agent include tolylene diisocyanate, triphenylmethane isocyanate, naphthylene-1,5-diisocyanate, hexamethylene diisocyanate, diphenylmethane diisocyanate, xylylene diisocyanate, and trimethylolpropane-modified tolylene diisocyanate. These may be used alone or in combination of two or more. Of these, tolylene diisocyanate, trimethylolpropane adducts thereof, and triphenylmethane isocyanate, which are trifunctional polyisocyanate compounds, are particularly preferred.

As an indicator of the degree of crosslinking, a gel fraction for determining the insoluble content after the adhesive layer is immersed in toluene for 24 hours is used. The gel fraction of the adhesive layer may be appropriately selected depending on the purpose without any limitation, and is preferably 10 wt % to 70 wt %, more preferably 25 wt % to 65 wt %, and still more preferably 35 wt % to 60 wt % in order to provide the adhesive layer with good cohesion and good adhesion.

The gel fraction refers to a value measured by the following method. An adhesive composition containing the adhesive resin and optionally the additives is applied to a release sheet so as to have a dry thickness of 50 μm. The coated sheet is dried at 100° C. for 3 minutes, aged at 40° C. for 2 days, and cut to a 50 mm square to prepare a sample. Next, the weight (G1) of the sample before being immersed in toluene is measured in advance, and the sample is immersed in a toluene solution at 23° C. for 24 hours. The toluene insoluble fraction is then separated by filtration through a 300-mesh metal screen, and the weight (G2) of the residue after drying at 110° C. for 1 hour is measured. The gel fraction is determined by formula (4) below. The weight (G3) of conductive fine particles in the sample is calculated from the weight (G1) of the sample and the composition of the adhesive composition.

Gel fraction (wt %)=(G2−G3)/(G1−G3)×100 formula (4)

### ——Rubber Adhesive Resin——

Examples of the rubber adhesive resin include, but are not limited to, those containing a rubber material that can be generally used as an adhesive resin, such as a synthetic rubber adhesive resin or a natural rubber adhesive resin, and optionally containing additives such as a tackifier resin.

Examples of the rubber material include block copolymers of an aromatic polyvinyl compound and a conjugated diene compound; and styrene resins such as a styrene-isoprene copolymer, a styrene-isoprene-styrene copolymer, a styrene-butadiene-styrene copolymer, a styrene-ethylene-butylene copolymer, and a styrene-ethylene-propylene copolymer. These may be used alone or in combination of two or more. Of these, the styrene resins are preferred. It is more preferable to use two or more of the styrene resins in combination because the adhesive sheet can be provided with excellent adhesive properties and retentivity, and it is particularly preferable to use the styrene-isoprene copolymer and the styrene-isoprene-styrene copolymer in combination.

The styrene resin for use may have a single structure such as a linear structure, a branched structure, or a multi-branched structure and may also have a combination of different structures. When a styrene resin abundant in the linear structure is used for the adhesive layer, the adhesive sheet can be provided with excellent adhesive properties. In contrast, a styrene resin having a branched structure or a multi-branched structure while also having styrene blocks at its molecular ends can take a pseudo crosslinked structure and provide high cohesive strength, and thus can provide high retentivity. Thus, these styrene resins are preferably used in combination according to required properties.

The styrene resin has a structural unit represented by chemical formula (1) below in an amount of preferably in the range of 10 wt % to 80 wt %, more preferably in the range of 12 wt % to 60 wt %, still more preferably in the range of 15 wt % to 40 wt %, particularly preferably in the range of 17 wt % to 35 wt %, relative to the total weight of the styrene resin. This can provide high adhesion and heat resistance.

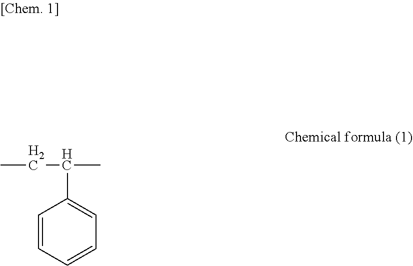

When a combination of the styrene-isoprene copolymer and the styrene-isoprene-styrene copolymer is used as the styrene resin, the content of the styrene-isoprene copolymer relative to the total weight of the styrene-isoprene copolymer and the styrene-isoprene-styrene copolymer is preferably 0 wt % to 80 wt %, more preferably 0 wt % to 77 wt %, still more preferably 0 wt % to 75 wt %, particularly preferably 0 wt % to 70 wt %. When the content of the styrene-isoprene copolymer is in the above preferred range, the adhesive sheet can be provided with both excellent adhesive properties and thermal durability.

The weight-average molecular weight of the styrene-isoprene copolymer, as measured by gel permeation chromatography (GPC) in terms of standard polystyrene, is preferably in the range of 10,000 to 800,000, more preferably in the range of 30,000 to 500,000, still more preferably in the range of 50,000 to 300,000. When the weight-average molecular weight of the styrene-isoprene copolymer is in the above preferred range, the adhesive sheet advantageously has good workability in a manufacturing process because thermal flowability and compatibility with a diluent solvent can be ensured and also has thermal durability.

The measurement of the weight-average molecular weight of the styrene-isoprene copolymer by GPC is performed using a GPC system (SC-8020, manufactured by Tosoh Corporation) in terms of standard polystyrene under the following measurement conditions.

### —Measurement Conditions—

Sample concentration: 0.5 wt % (tetrahydrofuran solution)
Sample injection volume: 100 μL
Eluent: tetrahydrofuran
Flow rate: 1.0 mL/min
Measurement temperature: 40° C.
Main column: TSKgel (registered trademark) GMHHR-H(20), two columns
Guard column: TSKgel HXL-H
Detector: differential refractometer
Molecular weight of standard polystyrene: 10,000 to 20,000,000 (manufactured by Tosoh Corporation)

The method for producing the styrene-isoprene copolymer is not particularly limited and may be appropriately selected from production methods known in the art. Examples include a method in which a styrene block and an isoprene block are sequentially polymerized by anionic living polymerization.

The method for producing the styrene-isoprene-styrene copolymer is not particularly limited and may be appropriately selected from production methods known in the art. Examples include a method in which a styrene block and an isoprene block are sequentially polymerized by anionic living polymerization and a method in which a block copolymer having a living active terminal is produced and then allowed to react with a coupling agent to produce a coupled block copolymer.

The method for producing a mixture of the styrene-isoprene copolymer and the styrene-isoprene-styrene copolymer is not particularly limited and may be appropriately selected from production methods known in the art. Examples include a method in which the styrene-isoprene copolymer and the styrene-isoprene-styrene copolymer produced by the above methods are mixed together.

Alternatively, the mixture of the styrene-isoprene copolymer and the styrene-isoprene-styrene copolymer can also be produced as the mixture at one time in one polymerization process.

More specifically, firstly, a styrene monomer is polymerized using an anionic polymerization initiator in a polymerization solvent by anionic living polymerization, thereby forming a polystyrene block having a living active terminal. Secondly, isoprene is polymerized from the living active terminal of the polystyrene block to obtain a styrene-isoprene diblock copolymer having a living active terminal. Thirdly, a part of the styrene-isoprene diblock copolymer having a living active terminal is reacted with a coupling agent to form a coupled styrene-isoprene-styrene block copolymer. Fourthly, the living active terminal of the rest of the styrene-isoprene diblock copolymer having a living active terminal is deactivated using a polymerization terminator to form a styrene-isoprene diblock copolymer.

The tackifier resin contained in the rubber adhesive resin may be appropriately selected depending on the purpose without any limitation, and it is preferable to use a tackifier resin having a softening point of 80° C. or higher. This can provide the adhesive sheet having high initial adhesion and thermal durability.

The tackifier resin is preferably a resin that is solid at normal temperature (23° C.), and specific examples thereof include petroleum resins such as C₅ petroleum resins, C₉ petroleum resins, C₅/C₉ petroleum resins, and alicyclic petroleum resins, polymerized rosin resins, terpene resins, rosin resins, terpene-phenol resins, styrene resins, coumarone-indene resins, xylene resins, and phenol resins. These may be used alone or in combination of two or more. Of these, the tackifier resin is preferably a combination of the C₅ petroleum resin and the polymerized rosin resin in order to achieve both higher initial adhesion and thermal durability.

The petroleum resin is readily compatible with the structural unit represented by chemical formula (1) above constituting the styrene resin and, as a result, can further improve the initial adhesive strength and the thermal durability of the adhesive sheet.

Examples of the C₅ petroleum resin include Escorez 1202, Escorez 1304, and Escorez 1401 (manufactured by Exxon Mobil Corporation), Wingtack 95 (manufactured by The Goodyear Tire & Rubber Company), Quintone K100, Quintone R100, and Quintone F100 (manufactured by Zeon Corporation), and Piccotac 95 and Piccopale 100 (manufactured by Rika Hercules Inc.).

Examples of the C₃ petroleum resin include Nisseki Neopolymer L-90, Nisseki Neopolymer 120, Nisseki Neopolymer 130, Nisseki Neopolymer 140, Nisseki Neopolymer 150, Nisseki Neopolymer 170S, Nisseki Neopolymer 160, Nisseki Neopolymer E-100, Nisseki Neopolymer E-130, Nisseki Neopolymer 130S, and Nisseki Neopolymer S (manufactured by JX Nippon Oil & Energy Corporation), and Petcoal (registered trademark) (manufactured by Tosoh Corporation).

The C₅/C₉ petroleum resin may be a copolymer of the C₅ petroleum resin and the C₉ petroleum resin, and, for example, Escorez 2101 (manufactured by Exxon Mobil Corporation), Quintone G115 (manufactured by Zeon Corporation), or Hercotack 1149 (manufactured by Rika Hercules Inc.) can be used.

The alicyclic petroleum resin can be obtained by hydrogenating the C₉ petroleum resin, and examples include Escorez 5300 (manufactured by Exxon Mobil Corporation), Arkon P-100 (manufactured by Arakawa Chemical Industries, Ltd.), and Rigalite R101 (manufactured by Rika Hercules Inc.).

The amount of the tackifier resin used may be appropriately selected depending on the purpose without any limitation, and is preferably in the range of 0 wt % to 100 wt %, more preferably in the range of 0 wt % to 70 wt %, still more preferably in the range of 0 wt % to 50 wt %, particularly preferably in the range of 0 wt % to 30 wt %, relative to the total amount of the components constituting the rubber adhesive resin. When the tackifier resin is used within the above preferred range, both a high elongation at break and thermal durability of the adhesive sheet are readily achieved while the interfacial adhesion between the adhesive layer and the substrate layer is increased.

The amount of the tackifier resin having a softening point of 80° C. or higher used may be appropriately selected depending on the purpose without any limitation, and is preferably in the range of 3 wt % to 100 wt % relative to the total amount of the styrene resin, more preferably in the range of 5 wt % to 80 wt %, and particularly preferably in the range of 5 wt % to 80 wt % in order to obtain the adhesive sheet having both higher adhesion and high thermal durability.

For the purpose of obtaining attaching properties and initial adhesion in a constant-temperature environment, the tackifier resin having a softening point of 80° C. or higher may be used in combination with a tackifier resin having a softening point of −5° C. or lower.

The tackifier resin having a softening point of −5° C. or lower is not particularly limited and may be appropriately selected depending on the purpose from the known tackifier resins described above, and it is preferable to use a tackifier resin that is liquid at room temperature.

Specific examples of the tackifier resin having a softening point of −5° C. or lower include liquid rubbers such as process oil, polyester, and polybutene. These may be used alone or in combination of two or more. Of these, the tackifier resin having a softening point of −5° C. or lower is preferably polybutene in order to exhibit higher initial adhesion.

The amount of the tackifier resin having a softening point of −5° C. or lower relative to the total amount of the tackifier resin is preferably in the range of 0 wt % to 40 wt %, more preferably in the range of 0 wt % to 30 wt %.

The amount of the tackifier resin having a softening point of −5° C. or lower relative to the total amount of the styrene resin is preferably in the range of 0 wt % to 40 wt %, and more preferably in the range of 0 wt % to 30 wt % because the initial adhesive strength can be improved to achieve good adhesion, and sufficient thermal durability can be obtained.

The weight ratio between the tackifier resin having a softening point of 80° C. or higher to the tackifier resin having a softening point of −5° C. or lower may be appropriately selected depending on the purpose without any limitation, and the weight ratio of the tackifier resin having a softening point of 80° C. or higher to the tackifier resin having a softening point of −5° C. or lower, as expressed by [weight of tackifier resin having softening point of 80° C. or higher/weight of tackifier resin having softening point of −5° C. or lower] is preferably in the range of 5 to 50, and more preferably in the range of 10 to 30 in order to obtain the adhesive sheet having both high initial adhesion and high retentivity.

The weight ratio between the styrene resin and the tackifier resin may be appropriately selected depending on the purpose without any limitation, and the weight ratio of the styrene resin to the tackifier resin, as expressed by [styrene resin/tackifier resin], is preferably in the range of 0.5 to 10.0, and more preferably in the range of 0.6 to 9.0 because the initial adhesive strength can be improved, and high thermal durability can be obtained. The weight ratio [styrene resin/tackifier resin] is preferably larger than 1 in order to prevent the adhesive sheet from peeling off due to its resilience when the adhesive sheet is attached to, for example, a curved portion of an adherend (resistance to resilience).

### —Other Components—

The other components in the adhesive layer are not particularly limited and may be appropriately selected as long as the properties of the adhesive sheet are not impaired. Examples include polymer components other than the adhesive resin; additives such as crosslinking agents, age resistors, UV absorbers, fillers, polymerization inhibitors, surface conditioners, antistatic agents, antifoaming agents, viscosity modifiers, light stabilizers, weathering stabilizers, heat stabilizers, antioxidants, leveling agents, organic pigments, inorganic pigments, pigment dispersants, plasticizers, softeners, flame retardants, metal deactivators, silica beads, and organic beads; and inorganic fillers such as silicon oxide, aluminum oxide, titanium oxide, zirconia, and antimony pentoxide. These may be used alone or in combination of two or more.

The content of the other components in the adhesive layer may be appropriately selected as long as the properties of the adhesive sheet are not impaired.

The adhesive layer is not particularly limited as long as it is disposed on a surface of the substrate layer and may be appropriately selected depending on, for example, the intended use. The adhesive layer may be disposed on only one surface or both surfaces of the substrate layer, and is preferably disposed on both surfaces.

### <<Stress at 25% Elongation of Adhesive Layer>>

The stress at 25% elongation of the adhesive layer may be appropriately selected depending on the purpose without any limitation, and is preferably 0.04 MPa to 0.4 MPa, more preferably 0.05 MPa to 0.1 MPa. When the stress at 25% elongation of the adhesive layer is in the above preferred range, the adhesive sheet can be provided with suitable adhesive strength and can be relatively easily peeled off when peeled off by stretching. However, if the stress at 25% elongation of the adhesive layer is less than 0.04 MPa, the adhesive sheet may be peeled off when a load is exerted in the shear direction of the adhesive sheet while hard adherends are fixed to each other, and if the stress at 25% elongation of the adhesive layer is more than 0.4 MPa, an excessive force may be required to stretch the adhesive sheet when the adhesive sheet is peeled off.

The stress at 25% elongation of the adhesive layer refers to a stress value measured when a dumbbell-shaped specimen punched from the adhesive layer to a gauge length of 20 mm and a width of 10 mm is stretched in the longitudinal direction at a tensile speed of 300 mm/min using a Tensilon tensile tester (model: RTF-1210, manufactured by A&D Company, Limited) in a measurement atmosphere of 23° C. and 50% RH and elongated by 25%.

### <Stress at Break of Adhesive Layer>>

The stress at break of the adhesive layer may be appropriately selected depending on the purpose without any limitation, and is preferably 0.5 MPa to 2.1 MPa, more preferably 1.0 MPa to 2.1 MPa. When the stress at break of the adhesive layer is in the above preferred range, breakage of the adhesive sheet can be suppressed when the adhesive sheet is peeled off by stretching, and the load for elongating the adhesive sheet will not be excessive, thus facilitating the operation of removal by peeling. However, if the stress at break of the adhesive layer is less than 0.5 MPa, the adhesive sheet may break when peeled off by stretching, and if the stress at break of the adhesive layer is more than 2.1 MPa, the adhesive sheet may not be sufficiently stretched and removed when stretched for removal. The force required when the adhesive sheet is deformed by stretching depends also on the thickness of the adhesive sheet. For example, also when the adhesive sheet has a large thickness and a high stress at break and is stretched for removal, the adhesive sheet may not be sufficiently stretched and removed.

The stress at break of the adhesive layer refers to a stress value measured when a dumbbell-shaped specimen punched from the adhesive layer to a gauge length of 20 mm and a width of 10 mm is stretched in the longitudinal direction at a tensile speed of 300 mm/min using a Tensilon tensile tester (model: RTF-1210, manufactured by A&D Company, Limited) in a measurement atmosphere of 23° C. and 50% RH and broken.

### <<Elongation at Break of Adhesive Layer>

The elongation at break of the adhesive layer may be appropriately selected depending on the purpose without any limitation, and is preferably 450% to 1,300%, more preferably 500% to 1,200%, still more preferably 600% to 1,100%. When the elongation at break of the adhesive layer is in the above preferred range, both suitable adhesion and removability can be achieved.

The elongation at break of the adhesive layer refers to a tensile elongation percentage measured when a dumbbell-shaped specimen punched from the adhesive layer to a gauge length of 20 mm and a width of 10 mm is stretched in the longitudinal direction at a tensile speed of 300 mm/min using a Tensilon tensile tester (model: RTF-1210, manufactured by A&D Company, Limited) in a measurement atmosphere of 23° C. and 50% RH and broken.

### <<Average Thickness of Adhesive Layer>>

The average thickness of the adhesive layer may be appropriately selected depending on the purpose without any limitation, and is preferably 5 μm to 150 μm, more preferably 20 μm to 120 μm, still more preferably 40 μm to 110 μm, particularly preferably 50 μm to 100 μm. The term “average thickness of an adhesive layer” means an average thickness of an adhesive layer on one surface of the adhesive sheet. When the adhesive layer is disposed on both surfaces of the adhesive sheet, the average thickness of the adhesive layer on one surface and the average thickness of the adhesive layer on the other surface may be the same or different, and is preferably the same.

As used herein, the term “average thickness of an adhesive layer” refers to an average value of thicknesses at a total of 25 points measured as follows: the adhesive sheet is cut across the width at five points at 100-mm intervals in the longitudinal direction, and in each of the sections, thicknesses of the adhesive layer at five points at 100-mm intervals in the width direction are measured using a TH-104 digital thickness gauge (manufactured by Tester Sangyo Co., Ltd.).

### <<Method for Forming Adhesive Layer>>

The method for forming the adhesive layer is not particularly limited and may be appropriately selected from known methods depending on the purpose. For example, the adhesive layer may be formed on at least one surface of the substrate layer by a hot-press method, a casting method using extrusion molding, a uniaxial orientation method, a sequential biaxial orientation method, a simultaneous biaxial orientation method, an inflation method, a tube method, a calendering method, or a solution method. Of these, the casting method using extrusion molding and the solution method are preferred.

Examples of the solution method include a method in which a solution containing the adhesive composition is applied directly to the substrate layer with a roll coater or the like and a method in which the adhesive layer is formed on a release sheet and then peeled off for use.

The release sheet may be appropriately selected depending on the purpose without any limitation, and examples include those obtained by performing a release treatment with a silicone resin or the like on one or both surfaces of the following: a sheet of paper such as kraft paper, glassine paper, or wood-free paper; a resin film of polyethylene, polypropylene (biaxially oriented polypropylene (OPP), uniaxially oriented polypropylene (CPP), polyethylene terephthalate (PET), or the like; a paper laminate obtained by stacking the sheet of paper and the resin film on top of each other; or the sheet of paper filled with clay, polyvinyl alcohol, or the like. These may be used alone or in combination of two or more.

### <Substrate Layer>

The substrate layer is not particularly limited and may be appropriately selected from known materials usable for the adhesive sheet as long as the properties of the adhesive sheet are not impaired. The substrate layer preferably contains the following substrate material and may optionally further contain other components.

The substrate layer may have a single-layer structure or a multilayer structure composed of two layers or three or more layers.

### <<Substrate Material>>

Examples of the substrate material include styrene resins such as styrene-isoprene copolymers, styrene-isoprene-styrene copolymers, styrene-butadiene-styrene copolymers, styrene-ethylene-butylene copolymers, and styrene-ethylene-propylene copolymers; polyurethane resins such as ester polyurethane and ether polyurethane; polyolefin resins such as polyethylene and polypropylene; polyester resins such as polyethylene terephthalate, polybutylene terephthalate, and polyethylene naphthalate; polystyrene; polycarbonate; polymethylpentene; polysulfone; polyether ether ketone; polyethersulfone; polyetherimide; polyimide films; fluorocarbon resins; nylon; and acrylic resins. These may be used alone or in combination of two or more, and are preferably used in combination of two or more.

Of these, the styrene resin and the polyurethane resin are preferred because a suitable elongation at break and a suitable stress at break are readily provided. The styrene resin is more preferred, and it is particularly preferable to use a styrene-isoprene copolymer and a styrene-isoprene-styrene copolymer in combination.

### —Styrene Resin—

The styrene resin is a resin having thermoplasticity, and thus exhibits excellent moldability, for example, in extrusion molding and injection molding and readily forms the substrate layer. Among resins generally referred to as thermoplastic resins, the styrene resin tends to provide a particularly high elongation at break and is suitable for use as the substrate of the adhesive sheet.

Therefore, the proportion of the styrene resin to all the resin components in the substrate material is preferably 50% to 100%, more preferably 60% to 100%, still more preferably 65% to 100%, particularly preferably 70% to 100%. When the proportion of the styrene resin is in the above preferred range, a substrate layer having a high elongation at break and a high stress at break can be obtained.

The styrene resin for use may have a single structure such as a linear structure, a branched structure, or a multi-branched structure and may also have a combination of different structures. A styrene resin abundant in the linear structure can provide the substrate layer with a high elongation at break. In contrast, a styrene resin having a branched structure or a multi-branched structure while also having styrene blocks at its molecular ends can take a pseudo crosslinked structure and provide high cohesive strength. Thus, these styrene resins are preferably used in combination according to required mechanical properties.

The styrene resin has the structural unit represented by chemical formula (1) above in an amount of preferably in the range of 13 wt % to 60 wt %, more preferably in the range of 15 wt % to 50 wt %, still more preferably in the range of 15 wt % to 45 wt %, particularly preferably in the range of 15 wt % to 35 wt %, relative to the total weight of the styrene resin. When the proportion of the structural unit represented by chemical formula (1) below relative to the total weight of the styrene resin is in the above preferred range, the elongation at break and the stress at break tend to be in the suitable ranges.

When a combination of the styrene-isoprene copolymer and the styrene-isoprene-styrene copolymer is used as the styrene resin, the content of the styrene-isoprene copolymer relative to the total weight of the styrene-isoprene copolymer and the styrene-isoprene-styrene copolymer is preferably 0 wt % to 80 wt %, more preferably in the range of 0 wt % to 70 wt %, still more preferably 0 wt % to 50 wt %, particularly preferably 0 wt % to 30 wt %. When the content of the styrene-isoprene copolymer is in the above preferred range, thermal durability can be simultaneously achieved while maintaining a high elongation at break and a high stress at break.

The weight-average molecular weight of the styrene-isoprene copolymer, as measured by gel permeation chromatography (GPC) in terms of standard polystyrene, is preferably in the range of 10,000 to 800,000, more preferably in the range of 30,000 to 500,000, still more preferably in the range of 50,000 to 300,000. When the weight-average molecular weight of the styrene-isoprene copolymer is in the above preferred range, the substrate layer advantageously has good workability in a manufacturing process because thermal flowability and compatibility with a diluent solvent can be ensured and also has thermal durability.

The measurement of the weight-average molecular weight of the styrene-isoprene copolymer by GPC is performed in the same manner as described in the section of “—Rubber adhesive resin—”.

The method for producing the styrene-isoprene copolymer, the styrene-isoprene-styrene copolymer, and a mixture of the styrene-isoprene copolymer and the styrene-isoprene-styrene copolymer is not particularly limited and may be appropriately selected from production methods known in the art. For example, the same method as described in the section of “—Rubber adhesive resin—” may be used.

### —Polyurethane Resin—

The polyurethane resin may be appropriately selected depending on the purpose without any limitation, and preferably has a softening point of 40° C. or higher, more preferably has a softening point of 50° C. or higher. The upper limit of the softening point is preferably 100° C. or lower. The softening point refers to a value measured in accordance with JIS K 2207 (dry-bulb method) (hereinafter, softening points are as defined here).

As the polyurethane resin, a reaction product of a polyol (b1-1) and a polyisocyanate (b1-2) is suitable for use.

The polyol (b1-1) may be appropriately selected depending on the purpose without any limitation, and examples include polyester polyol, polyether polyol, polycarbonate polyol, and acrylic polyol. These may be used alone or in combination of two or more. Of these, the polyol (b1-1) is preferably polyester polyol or polyether polyol because the mechanical properties of the substrate layer can be provided. In the substrate layer, polyester polyol is preferably used when heat resistance is required, and polyether polyol is preferably used when water resistance or biodegradation resistance is required.

Examples of the polyester polyol include polyesters formed by esterification reaction of low-molecular-weight polyol and polycarboxylic acid, polyesters formed by ring-opening polymerization reaction of cyclic ester compounds such as ε-caprolactone, and copolyesters thereof.

Examples of the low-molecular-weight polyol that can be used to produce the polyester polyol include aliphatic alkylene glycols such as ethylene glycol, propylene glycol, 1,4-butanediol, 1,6-hexanediol, diethylene glycol, neopentyl glycol, and 1,3-butanediol and cyclohexanedimethanol, each having a weight-average molecular weight of about 50 to 300.

Examples of the polycarboxylic acid include aliphatic dicarboxylic acids such as succinic acid, adipic acid, sebacic acid, and dodecanedicarboxylic acid; aromatic dicarboxylic acids such as terephthalic acid, isophthalic acid, phthalic acid, and naphthalenedicarboxylic acid; and anhydrides and esterified products thereof.

Examples of the polyether polyol include those obtained by the addition polymerization of an alkylene oxide using, as initiators, one or more compounds having two or more active hydrogen atoms.

As the polycarbonate polyol, for example, a reaction product of a carbonate and/or phosgene and a low-molecular-weight polyol described below can be used.

Examples of the carbonate include methyl carbonate, dimethyl carbonate, ethyl carbonate, diethyl carbonate, cyclo carbonate, and diphenyl carbonate.

Examples of the low-molecular-weight polyol that can be used to produce the polycarbonate polyol and can react with the carbonate and/or phosgene include ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, 2,3-butanediol, 1,5-pentanediol, 1,5-hexanediol, 1,6-hexanediol, 2,5-hexanediol, 1,7-heptanediol, 1,8-octanediol, 1,9-nonanediol, 1,10-decanediol, 1,11-undecanediol, 1,12-dodecanediol, 2-methyl-1,3-propanediol, neopentyl glycol, 2-butyl-2-ethyl-1,3-propanediol, 3-methyl-1,5-pentanediol, 2-ethyl-1,3-hexanediol, 2-methyl-1,8-octanediol, 1,4-cyclohexanedimethanol, hydroquinone, resorcin, bisphenol A, bisphenol F, and 4,4′-biphenol.

The polyisocyanate (b1-2) may be appropriately selected depending on the purpose without any limitation. Examples of usable polyisocyanates include alicyclic polyisocyanates, aliphatic polyisocyanates, and aromatic polyisocyanates, and, for example, an alicyclic polyisocyanate may be used. These may be used alone or in combination of two or more.

Examples of the alicyclic polyisocyanate include isophorone diisocyanate, 1,3-bis (isocyanatomethyl)cyclohexane, 4,4′-dicyclohexylmethane diisocyanate, 2,4-methylcyclohexane diisocyanate, 2,6-methylcyclohexane diisocyanate, cyclohexylene diisocyanate, methylcyclohexylene diisocyanate, bis(2-isocyanatoethyl)-4-cyclohexylene-1,2-dicarboxylate, 2,5-norbornane diisocyanate, 2,6-norbornane diisocyanate, dimer acid diisocyanate, and bicycloheptane triisocyanate. These may be used alone or in combination of two or more.

The method for producing a polyurethane resin (b1) by reacting the polyol (b1-1) with the polyisocyanate (b1-2) is not particularly limited and may be appropriately selected from production methods known in the art. Examples include a method in which the polyol (b1-1) placed in a reaction vessel is heated under normal-pressure or reduced-pressure conditions to remove water, and then the polyisocyanate (b1-2) is supplied batchwise or portionwise to cause a reaction.

In the reaction between the polyol (b1-1) and the polyisocyanate (b1-2), the equivalent ratio of isocyanate groups (NCO) of the polyisocyanate (b1-2) to hydroxyl groups (OH) of the polyol (b1-1) (NCO/OH equivalent ratio) is preferably in the range of 1.0 to 20.0, more preferably in the range of 1.1 to 13.0, still more preferably in the range of 1.2 to 5.0, particularly preferably in the range of 1.5 to 3.0.

The conditions for the reaction between the polyol (b1-1) and the polyisocyanate (b1-2) are not particularly limited and may be appropriately selected taking into account various conditions such as safety, quality, and cost. The reaction temperature is preferably 70° C. to 120° C., and the reaction time is preferably 30 minutes to 5 hours.

When the polyol (b1-1) and the polyisocyanate (b1-2) are reacted together, a catalyst such as a tertiary amine catalyst or an organic metal catalyst can be used as required.

The reaction may be conducted in an environment without a solvent or in the presence of an organic solvent.

The organic solvent may be appropriately selected depending on the purpose without any limitation, and examples include ester solvents such as methyl acetate, ethyl acetate, propyl acetate, and butyl acetate; ketone solvents such as acetone, methyl ethyl ketone, methyl butyl ketone, and cyclohexanone; ether ester solvents such as methyl cellosolve acetate and butyl cellosolve acetate; aromatic hydrocarbon solvents such as toluene and xylene; and amide solvents such as dimethylformamide and dimethylacetamide. These may be used alone or in combination of two or more.

The organic solvent may be removed during or after the production of the polyurethane resin (b1) by an appropriate method such as heating under reduced pressure or drying under normal pressure.

### —Other Components—

The other components in the substrate layer are not particularly limited and may be appropriately selected as long as the properties of the adhesive sheet are not impaired. Examples include tackifier resins; polymer components other than the substrate material; additives such as crosslinking agents, age resistors, UV absorbers, fillers, polymerization inhibitors, surface conditioners, antistatic agents, antifoaming agents, viscosity modifiers, light stabilizers, weathering stabilizers, heat stabilizers, antioxidants, leveling agents, organic pigments, inorganic pigments, pigment dispersants, silica beads, and organic beads; and inorganic fillers such as silicon oxide, aluminum oxide, titanium oxide, zirconia, and antimony pentoxide. These may be used alone or in combination of two or more.

The content of the other components in the substrate layer may be appropriately selected as long as the properties of the adhesive sheet are not impaired.

The tackifier resin can be used for the purpose of increasing the adhesion between the adhesive layer and the substrate layer in the adhesive sheet or increasing heat resistance.

The tackifier resin may be appropriately selected depending on the purpose without any limitation, and preferably has a softening point of 80° C. or higher, more preferably 90° C. or higher, still more preferably 100° C. or higher, particularly preferably 110° C. or higher.

As the tackifier resin, for example, those described in the section of “—Rubber adhesive resin—” can be used, and preferred features thereof are also the same.

The age resistor is not particularly limited and may be appropriately selected from known age resistors depending on the purpose. Examples include phenol-based age resistors, phosphorus-based age resistors (also referred to as “processing stabilizers”), amine-based age resistors, and imidazole-based age resistors. These may be used alone or in combination of two or more. Of these, the phenol-based age resistors and the phosphorus-based age resistors are preferred, and the combined use thereof can effectively improve the thermal stability of the substrate material, and as a result, an adhesive sheet that maintains good initial adhesion and has higher thermal durability can be advantageously obtained. The phosphorus-based age resistors may be slightly discolored (yellowed) over time in a high-temperature environment, and thus the amount thereof is preferably set as appropriate taking into account the balance of the initial adhesion, thermal durability, and prevention of discoloration.

As the phenol-based age resistor, a phenolic compound generally having a sterically hindering group, typically, a monophenolic compound, a bisphenolic compound, or a polyphenolic compound, can be used. Specific examples include 2,6-di-t-butyl-4-methylphenol, 2,2′-methylenebis(4-methyl-6-t-butylphenol), 2,2′-methylenebis(4-ethyl-6-t-butylphenol), 4,4′-thiobis(6-t-butyl-3-methylphenol), 4,4′-butylidenebis-(3-methyl-6-t-butylphenol), tetrakis-[methylene-3-(3′5′-di-t-butyl-4-hydroxyphenyl)propionate]methane, and n-octadecyl-3-(4′-hydroxy-3′5′-di-t-butylphenyl)propionate. These may be used alone or in combination of two or more.

The amount of the phenol-based age resistor used may be appropriately selected depending on the purpose without any limitation, and is preferably in the range of 0.1 parts by weight to 5 parts by weight relative to 100 parts by weight of the substrate material. When the amount of the phenol-based age resistor is in the range of 0.5 parts by weight to 3 parts by weight, the thermal stability of the substrate material can be effectively improved, and as a result, an adhesive sheet that maintains good initial adhesion and has higher thermal durability can be obtained.

### <<Stress at 25% Elongation of Substrate Layer>>

The stress at 25% elongation of the substrate layer may be appropriately selected depending on the purpose without any limitation, and is preferably 0.2 MPa to 10.0 MPa, more preferably 0.2 MPa to 5.0 MPa, still more preferably 0.2 MPa to 3.0 MPa, particularly preferably 0.2 MPa to 2.0 MPa. When the stress at 25% elongation of the substrate layer is in the above preferred range, the adhesive sheet can be provided with suitable adhesive strength and can be relatively easily peeled off when peeled off by stretching. However, if the stress at 25% elongation of the substrate layer is less than 0.2 MPa, the adhesive sheet may be peeled off when a load is exerted in the shear direction of the adhesive sheet while hard adherends are fixed to each other, and if the stress at 25% elongation of the substrate layer is more than 10.0 MPa, an excessive force may be required to stretch the adhesive sheet when the adhesive sheet is peeled off.

The stress at 25% elongation of the substrate layer refers to a stress value measured when a dumbbell-shaped specimen punched from the substrate layer to a gauge length of 20 mm and a width of 6 mm is stretched in the longitudinal direction at a tensile speed of 500 mm/min using a Tensilon tensile tester (model: RTF-1210, manufactured by A&D Company, Limited) in a measurement atmosphere of 23° C. and 50% RH and elongated by 25%.

### <<Stress at Break of Substrate Layer>

The stress at break of the substrate layer may be appropriately selected depending on the purpose without any limitation, and is preferably 1.5 MPa to 100.0 MPa, more preferably 7.0 MPa to 50.0 MPa, still more preferably 7.0 MPa to 40.0 MPa, particularly preferably 8.0 MPa to 35.0 MPa. When the stress at break of the substrate layer is in the above preferred range, breakage of the adhesive sheet can be suppressed when the adhesive sheet is peeled off by stretching, and the load for elongating the adhesive sheet will not be excessive, thus facilitating the operation of removal by peeling. However, if the stress at break of the substrate layer is less than 1.5 MPa, the adhesive sheet may break when peeled off by stretching, and if the stress at break of the substrate layer is more than 100.0 MPa, the adhesive sheet may not be sufficiently stretched and removed when stretched for removal. The force required when the adhesive sheet is deformed by stretching depends also on the thickness of the adhesive sheet. For example, also when the adhesive sheet has a large thickness and a high stress at break and is stretched for removal, the adhesive sheet may not be sufficiently stretched and removed.

The stress at break of the substrate layer refers to a stress value measured when a dumbbell-shaped specimen punched from the substrate layer to a gauge length of 20 mm and a width of 6 mm is stretched in the longitudinal direction at a tensile speed of 500 mm/min using a Tensilon tensile tester (model: RTF-1210, manufactured by A&D Company, Limited) in a measurement atmosphere of 23° C. and 50% RH and broken.

### <<Elongation at Break of Substrate Layer>>

The elongation at break of the substrate layer may be appropriately selected depending on the purpose without any limitation, and is preferably 200% to 1,300%, more preferably 400% to 1,300%, still more preferably 700% to 1,300%. When the elongation at break of the substrate layer is 200% or more, even if the adhesive sheet is firmly bonded to an adherend, the stress for stretching in the horizontal to vertical direction with respect to the attached surface of the adherend in removing the adhesive sheet will not be excessively high, and the adhesive sheet can be easily peeled off without being excessively elongated. When the elongation at break is 1,300% or less, the length of stretch in the horizontal to vertical direction with respect to the attached surface of the adherend in removing the adhesive sheet will not be excessively large, which enables an operation in a small space. However, if the elongation at break is less than 200%, when the adhesive sheet is peeled off by stretching in the horizontal to vertical direction with respect to the attached surface of the adherend to remove the adhesive sheet, breakage may occur to prevent peeling, and if the elongation at break is more than 1,300%, the length of stretch in the horizontal to vertical direction with respect to the attached surface of the adherend in removing the adhesive sheet may be excessively large, thus leading to poor workability.

The elongation at break of the substrate layer refers to a tensile elongation percentage measured when a dumbbell-shaped specimen punched from the substrate layer to a gauge length of 20 mm and a width of 6 mm is stretched in the longitudinal direction at a tensile speed of 500 mm/min using a Tensilon tensile tester (model: RTF-1210, manufactured by A&D Company, Limited) in a measurement atmosphere of 23° C. and 50% RH and broken.

### <<Average Thickness of Substrate Layer>>

The average thickness of the substrate layer may be appropriately selected depending on, for example, the intended use without any limitation, and is preferably 10 μm to 500 μm, more preferably 10 μm to 300 μm, still more preferably 20 μm to 200 μm, particularly preferably 20 μm to 100 μm. When the average thickness of the substrate layer is in the above preferred range, it is advantageous in that the adhesive sheet readily conforms to a deformation of an adherend to exhibit high adhesive strength and that the stress required when the adhesive sheet including the substrate layer is removed while being stretched in the horizontal to vertical direction with respect to the attached surface of the adherend will not be excessively high.

As used herein, the term “average thickness of a substrate layer” refers to an average value of thicknesses at a total of 25 points measured as follows: the substrate layer is cut in a direction (also referred to as the “width direction”) perpendicular to the longitudinal direction at five points at 100-mm intervals in the longitudinal direction, and in each of the sections, thicknesses at five points at 100-mm intervals in the width direction are measured using a TH-104 digital thickness gauge (manufactured by Tester Sangyo Co., Ltd.).

### <<Average Thickness of Adhesive Layer/Average Thickness of Substrate Layer>>

The thickness ratio between the adhesive layer and the substrate layer may be appropriately selected depending on the purpose without any limitation, and the ratio of the average thickness of the adhesive layer to the average thickness of the substrate layer, as expressed by [average thickness of adhesive layer/average thickness of substrate layer], is preferably 1/5 to 5/1, more preferably 1/3 to 3/1, still more preferably 1/1 to 2/1. When the ratio of the average thickness of the adhesive layer to the average thickness of the substrate layer is in the above preferred range, the adhesive sheet can be provided with high adhesion and high removability. However, if the ratio is larger than 5/1, the adhesive layer alone may remain on an adherend in the step of removing the adhesive sheet. If the ratio is smaller than 1/5, the adhesive layer cannot conform to an adherend in the case where the surface of the adherend has, for example, an uneven shape, as a result of which the adhesive strength may be significantly reduced.

### <<Method for Forming Substrate Layer>>

The method for forming the substrate layer is not particularly limited and may be appropriately selected from known methods depending on, for example, the mechanical strength required for the adhesive sheet. Examples include a hot-press method, a casting method using extrusion molding, a uniaxial orientation method, a sequential biaxial orientation method, a simultaneous biaxial orientation method, an inflation method, a tube method, a calendering method, and a solution method. These methods may be used alone or in combination of two or more. Of these, the casting method using extrusion molding, the inflation method, the tube method, the calendering method, and the solution method are preferred in order to impart suitable flexibility and stretchability to the substrate layer.

The substrate layer may be subjected to surface treatment for the purpose of further improving the adhesion to the adhesive layer.

The surface treatment is not particularly limited and may be appropriately selected from known methods as long as the properties of the adhesive sheet are not impaired. Examples include sandblasting, surface polishing and rubbing, corona discharge treatment, chromic acid treatment, flame treatment, hot air treatment, ozone treatment, UV irradiation treatment, and oxidation treatment.

### <Other Layers>

The other layers of the adhesive sheet may be appropriately selected depending on the purpose without any limitation, and examples include primer layers, antistatic layers, non-flammable layers, decorative layers, electrically conductive layers, thermally conductive layers, and release layers.

The adhesive sheet at least including the adhesive layer and the substrate layer described above and optionally further including the other layers preferably has the following properties.

### <Hardness (Shore A Hardness) of Adhesive Sheet>

The hardness (Shore A hardness) of the adhesive sheet may be appropriately selected depending on the purpose without any limitation, and is preferably 10 to 90, more preferably 20 to 85, still more preferably 64 to 85. When the Shore A hardness of the adhesive sheet is in the above preferred range, the operation of removal of the adhesive sheet by peeling is facilitated. However, if the Shore A hardness is less than 10, the adhesive sheet may break when peeled off by stretching, and if the Shore A hardness is more than 90, when the adhesive sheet is stretched for removal, the stress for stretching may be excessively high to prevent removal.

The Shore A hardness of the adhesive sheet refers to a value measured in accordance with JIS K 6253 using a durometer (spring-type rubber hardness tester) (model: GS-719G, manufactured by Teclock Corporation).

### <Stress at 25% Elongation of Adhesive Sheet>

The stress at 25% elongation of the adhesive sheet is 0.15 Mpa to 82 Mpa, preferably 0.15 Mpa to 10 Mpa, more preferably 0.15 Mpa to 5 Mpa, still more preferably 0.15 Mpa to 2 Mpa. When the stress at 25% elongation of the adhesive sheet is 0.15 Mpa to 82 Mpa, the adhesive sheet can be provided with suitable adhesive strength and can be relatively easily peeled off when peeled off by stretching. However, if the stress at 25% elongation of the adhesive sheet is less than 0.15 Mpa, the adhesive sheet may be peeled off when a load is exerted in the shear direction of the adhesive sheet while hard adherends are fixed to each other. If the stress at 25% elongation of the adhesive sheet is more than 82 Mpa, an excessive force is required to stretch the adhesive sheet when the adhesive sheet is peeled off.

The stress at 25% elongation of the adhesive sheet refers to a stress value measured when a dumbbell-shaped specimen punched from the adhesive sheet to a gauge length of 20 mm and a width of 6 mm is stretched in the longitudinal direction at a tensile speed of 500 mm/min using a Tensilon tensile tester (model: RTF-1210, manufactured by A&D Company, Limited) in a measurement atmosphere of 23° C. and 50% RH and elongated by 25%.

### <Stress at Break of Adhesive Sheet>

The stress at break of the adhesive sheet may be appropriately selected depending on the purpose without any limitation, and is preferably 1.5 MPa to 100.0 MPa, more preferably 5.0 MPa to 50.0 MPa, still more preferably 5.0 MPa to 40.0 MPa, particularly preferably 5.0 MPa to 35.0 MPa. When the stress at break of the adhesive sheet is in the above preferred range, breakage of the adhesive sheet can be suppressed when the adhesive sheet is peeled off by stretching, and the load for elongating the adhesive sheet will not be excessive, thus facilitating the operation of removal by peeling. However, if the stress at break of the adhesive sheet is less than 1.5 MPa, the adhesive sheet may break when peeled off by stretching, and if the stress at break of the adhesive sheet is more than 100.0 MPa, the adhesive sheet may not be sufficiently stretched and removed when stretched for removal. The force required when the adhesive sheet is deformed by stretching depends also on the thickness of the adhesive sheet. For example, also when the adhesive sheet has a large thickness and a high stress at break and is stretched for removal, the adhesive sheet may not be sufficiently stretched and removed.

The stress at break of the adhesive sheet refers to a stress value measured when a dumbbell-shaped specimen punched from the adhesive sheet to a gauge length of 20 mm and a width of 6 mm is stretched in the longitudinal direction at a tensile speed of 500 mm/min using a Tensilon tensile tester (model: RTF-1210, manufactured by A&D Company, Limited) in a measurement atmosphere of 23° C. and 50% RH and broken.

### <Elongation at Break of Adhesive Sheet>

The elongation at break of the adhesive sheet may be appropriately selected depending on the purpose without any limitation, and is preferably 500% to 2,000%, more preferably 600% to 1,800%, still more preferably 800% to 1,800%. When the elongation at break of the adhesive sheet is 500% or more, even if the adhesive sheet is firmly bonded to an adherend, the stress for stretching in the horizontal to vertical direction with respect to the attached surface of the adherend in removing the adhesive sheet will not be excessively high, and the adhesive sheet can be easily peeled off without being excessively elongated. When the elongation at break is 2,000% or less, the length of stretch in the horizontal to vertical direction with respect to the attached surface of the adherend in removing the adhesive sheet will not be excessively large, which enables an operation in a small space. However, if the elongation at break is less than 500%, when the adhesive sheet is peeled off by stretching in the horizontal to vertical direction with respect to the attached surface of the adherend to remove the adhesive sheet, breakage may occur to prevent peeling, and if the elongation at break is more than 1,300%, the length of stretch in the horizontal to vertical direction with respect to the attached surface of the adherend in removing the adhesive sheet may be excessively large, thus leading to poor workability.

The elongation at break of the adhesive sheet refers to a tensile elongation percentage measured when a dumbbell-shaped specimen punched from the adhesive sheet to a gauge length of 20 mm and a width of 6 mm is stretched in the longitudinal direction at a tensile speed of 500 mm/min using a Tensilon tensile tester (model: RTF-1210, manufactured by A&D Company, Limited) in a measurement atmosphere of 23° C. and 50% RH and broken.

### <Removability (in Peeling by Vertical Stretching) of Adhesive Sheet>

The adhesive sheet can be easily peeled off by stretching even if the direction of the stretching is the perpendicular direction (90° direction) with respect to an attached surface of an adherend. In this DESCRIPTION, the peelability exhibited when the adhesive sheet is peeled off by stretching in the perpendicular direction with respect to an attached surface of an adherend is referred to as “removability (in peeling by vertical stretching)”. The removability (in peeling by vertical stretching) can be determined, for example, in a manner described in <<Evaluation of removability (in peeling by vertical stretching)>> in EXAMPLES described later. In the evaluation of the removability (in peeling by vertical stretching), if the adhesive sheet is less likely to break, and few adhesive composition residues are left on an adherend after the adhesive sheet has been peeled off, the adhesive sheet has high removability (in peeling by vertical stretching); and if the adhesive sheet does not break, and no adhesive composition residue is left on an adherend after the adhesive sheet has been peeled off, the adhesive sheet has higher removability (in peeling by vertical stretching).

### <Impact Resistance of Adhesive Sheet>

The adhesive sheet also has high impact resistance. The impact resistance can be determined, for example, in a manner described in <<Evaluation of impact resistance>> in EXAMPLES described later. In the evaluation of the impact resistance, the height of an impact core at which peeling or fracture of the adhesive sheet occurs may be appropriately selected as long as the advantageous effects of the present invention are not impaired, and is preferably 30 cm or more, more preferably 40 cm or more, still more preferably 50 cm or more, particularly preferably 60 cm or more. If the height is less than 30 cm, sufficient impact resistance cannot be provided.

### <180° Peel Adhesive Strength of Adhesive Sheet>

The 180° peel adhesive strength of the adhesive sheet may be appropriately selected depending on the purpose without any limitation, and is preferably 3 N/20 mm to 35 N/20 mm, more preferably 4 N/20 mm to 30 N/20 mm, still more preferably 5 N/20 mm to 25 N/20 mm. When the 180° peel adhesive strength is in the above preferred range, the adhesive sheet has appropriate adhesive strength so as not to undergo peeling or slipping from an adherend, while the adhesive sheet can be readily peeled off when removed by being stretched in the horizontal to vertical direction with respect to the attached surface of the adherend.

The 180° peel adhesive strength of the adhesive sheet refers to a value measured in accordance with JIS Z 0237.

### <Shear Adhesive Strength of Adhesive Sheet>

The adhesive sheet is less easily peeled off even when a load is exerted in the shear direction of the adhesive sheet, that is, has high shear adhesive strength. The shear direction is not particularly limited as long as it is a direction perpendicular to the thickness direction of the adhesive sheet.

The shear adhesive strength of the adhesive sheet may be appropriately selected as long as the advantageous effects of the present invention are not impaired, and is preferably at least 100 N/4 cm², more preferably at least 120 N/4 cm², still more preferably at least 150 N/4 cm², particularly preferably at least 200 N/4 cm². When the shear adhesive strength is in the above preferred range, slipping that may occur when a stress in the shear direction is exerted on an adherend fixed with the adhesive sheet can be suppressed.

The shear adhesive strength of the adhesive sheet can be determined, for example, in a manner described in <<Evaluation of shear adhesive strength> in EXAMPLES described later.

### <Cleavage Adhesive Strength of Adhesive Sheet>

The adhesive sheet is less easily peeled off even when a load is exerted in the cleavage direction (also referred to as the “thickness direction”) of the adhesive sheet, that is, has high cleavage adhesive strength. The cleavage adhesive strength of the adhesive sheet may be appropriately selected as long as the advantageous effects of the present invention are not impaired, and is preferably at least 80 N/4 cm², more preferably at least 100 N/4 cm², still more preferably at least 120 N/4 cm². When the cleavage adhesive strength is in the above preferred range, peeling that may occur when a stress in the cleavage direction is exerted on an adherend fixed with the adhesive sheet can be suppressed. The cleavage adhesive strength of the adhesive sheet can be determined, for example, in a manner described in <<Evaluation of cleavage adhesive strength>> in EXAMPLES described later.

### <Average Thickness of Adhesive Sheet>

The average thickness of the adhesive sheet may be appropriately selected depending on, for example, the average thicknesses of the adhesive layer and the substrate layer without any limitation, and is preferably 15 μm to 800 μm, more preferably 30 μm to 540 μm, still more preferably 60 μm to 320 μm, particularly preferably 70 μm to 250 μm.

As used herein, the term “average thickness of an adhesive layer” refers to an average value of thicknesses at a total of 25 points measured as follows: the adhesive sheet is cut across the width at five points at 100-mm intervals in the longitudinal direction, and in each of the sections, thicknesses of the adhesive layer at five points at 100-mm intervals in the width direction are measured using a TH-104 digital thickness gauge (manufactured by Tester Sangyo Co., Ltd.).

### <Average Width of Adhesive Sheet>

The average width of the adhesive sheet may be appropriately selected depending on, for example, the intended use without any limitation, and is preferably 1 mm to 3,000 mm, more preferably 50 mm to 2,500 mm, still more preferably 400 mm to 2,500 mm. When the adhesive sheet is used for, for example, fixation, the average width of the adhesive sheet may be appropriately adjusted depending on, for example, the attachment target.

As used herein, the term “average width of a substrate layer” refers to an average value of widths measured at five points at 100-mm intervals in the longitudinal direction of the substrate layer using a known measure such as a ruler (scale), a tape measure, or a steel tape measure.

### <Method for Producing Adhesive Sheet>

The method for producing the adhesive sheet is not particularly limited as long as the adhesive layer and the substrate layer are included and may be appropriately selected from known methods. The method preferably includes an adhesive layer forming step, a substrate layer forming step, and a layer stacking step, and optionally further includes an another layer forming step. The adhesive sheet can also be produced by a simultaneous multilayer forming step in which the adhesive layer forming step and the substrate layer forming step are simultaneously performed.

### <<Adhesive Layer Forming Step>>

The adhesive layer forming step is not particularly limited as long as the adhesive layer can be formed and may be appropriately selected depending on the purpose. Examples include the same methods as described in “<<Method for forming adhesive layer>>”, and preferred examples thereof are also the same.

### <<Substrate Layer Forming Step>>

The substrate layer forming step is not particularly limited as long as the substrate layer can be formed and may be appropriately selected depending on the purpose. Examples include the same methods as described in “<<Method for forming substrate layer>>”, and preferred examples thereof are also the same.

### <<Layer Stacking Step>>

The layer stacking step is a step of stacking the substrate layer and the adhesive layer together. The method for stacking the substrate layer and the adhesive layer together is not particularly limited and may be appropriately selected from known methods. Examples include lamination of the substrate layer and the adhesive layer under pressure.

The adhesive sheet can be easily peeled off by stretching even if the direction of the stretching is the perpendicular direction with respect to an attached surface of an attached object, is less likely to break even when the substrate of the adhesive sheet is thin, and is excellent in impact resistance, shear adhesive strength, and cleavage adhesive strength. Thus, the adhesive sheet is suitable for use in, for example, part fixation in various industrial fields, e.g., fixation of metal sheets constituting relatively large electronic appliances such as flat-screen televisions, household electrical appliances, and OA appliances, fixation of exterior parts to housings, and fixation of exterior parts or rigid parts such as batteries to relatively small electronic appliances such as portable electronic terminals, cameras, and personal computers; temporary fixation of such parts; and labels displaying product information.

### EXAMPLES

The present invention will now be described in detail with reference to Examples and Comparative Examples, but these Examples are not intended to limit the present invention.

In producing adhesive sheets 1 to 16 of Examples 1 to 11 and Comparative Examples 1 to 6 below, resin compositions (1) to (5) for substrate layers and adhesive compositions (1) to (12) for adhesive layers described below were used.

### <Resin Composition (1)>

The resin composition (1) used was a mixture (hereinafter also referred to as “SIS”) of a styrene-isoprene copolymer and a styrene-isoprene-styrene copolymer, with a styrene-derived structural unit represented by chemical formula (1) below being 25 wt % and the proportion of the styrene-isoprene copolymer to the total amount of the resin composition (1) being 17 wt %.

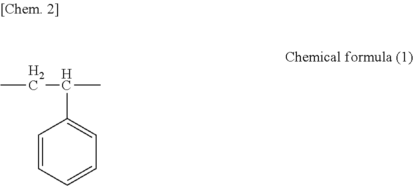

### <Resin Composition (2)>

The resin composition (2) used was an ester polyurethane compound (MOBILON FILM MF100T, manufactured by Nisshinbo Textile Inc.).

### <Resin Composition (3)>

The resin composition (3) used was a mixture (SIS) of a styrene-isoprene copolymer and a styrene-isoprene-styrene copolymer, with the styrene-derived structural unit represented by chemical formula (1) above being 15 wt % and the proportion of the styrene-isoprene copolymer to the total amount of the resin composition (3) being 12 wt %.

### <Resin Composition (4)>

The resin composition (4) used was a mixture (SIS) of a styrene-isoprene copolymer and a styrene-isoprene-styrene copolymer, with the styrene-derived structural unit represented by chemical formula (1) above being 15 wt % and the proportion of the styrene-isoprene copolymer to the total amount of the resin composition (4) being 80 wt %.

### <Resin Composition (5)>

The resin composition (5) used was a PET film (Lumirror (registered trademark) S10, 100 μm thick, manufactured by Toray Industries, Inc.).

### <Preparation of Adhesive Composition (1)>

In a reaction vessel equipped with a stirrer, a reflux condenser, a nitrogen inlet tube, a thermometer, and a dropping funnel, 75.94 parts by weight of n-butyl acrylate, 5 parts by weight of 2-ethylhexyl acrylate, 15 parts by weight of cyclohexyl acrylate, 4 parts by weight of acrylic acid, 0.06 parts by weight of 4-hydroxybutyl acrylate, and 200 parts by weight of ethyl acetate were placed, and under stirring, the temperature was increased to 65° C. under a stream of nitrogen to obtain a mixture (1). Next, 4 parts by weight (solids content: 2.5 wt %) of a solution of 2,2′-azobisisobutyronitrile in ethyl acetate prepared in advance was added to the mixture (1), and under stirring, the resulting mixture was held at 65° C. for 10 hours to obtain a mixture (2). Next, the mixture (2) was diluted with 98 parts by weight of ethyl acetate and filtered through a 200-mesh metal screen to thereby obtain an acrylic copolymer solution (1) having a weight-average molecular weight of 1,600,000 (in terms of polystyrene). Next, 100 parts by weight of the acrylic copolymer solution (1) were mixed with 5 parts by weight of a polymerized rosin ester tackifier resin (D-125, Arakawa Chemical Industries, Ltd.) and 15 parts by weight of a petroleum tackifier resin (FTR (registered trademark) 6125, manufactured by Mitsui Chemicals, Inc.) under stirring, and ethyl acetate was then added to the resulting mixture to thereby obtain an adhesive resin solution (1) with a solids content of 31 wt %.

Next, to the adhesive resin solution (1) obtained, a filler 1 (aluminum hydroxide, polygonal, BW153, manufactured by Nippon Light Metal Company, Ltd., volume-average particle size: 18 μm, particle size distribution (D₉₀/D₁₀): 12.3) in an amount of 30 parts by weight relative to 100 parts by weight of the solids content of the adhesive resin solution (1) was added, and then a crosslinking agent (BURNOCK D-40, manufactured by DIC Corporation; trimethylolpropane adduct of tolylene diisocyanate, isocyanate group content: 7 wt %, non-volatile content: 40 wt %) in an amount of 1.3 parts by weight relative to 100 parts by weight of the adhesive resin solution (1) was added and homogeneously mixed under stirring to obtain an adhesive composition (1).

The particle size distribution (D₉₀/D₁₀) of the filler particles is a value obtained by measuring the particle size of the filler particles with a measuring machine (Microtrac) using a laser diffraction scattering method and converting the measurements into a particle size distribution.

### <Preparation of Adhesive Composition (2)>

An adhesive composition (2) was prepared in the same manner as in “Preparation of adhesive composition (1)” above except that the type and amount of filler were changed to the type and amount shown in Table 1 below.

The filler 2 is composed of nickel powder (Type 123, manufactured by Inco Limited, polygonal, volume-average particle size: 11.9 μm) and has a particle size distribution (D₉₀/D₁₀), as measured in the same manner as that of the filler 1, of 4.2.

### <Preparation of Adhesive Composition (3)>

An adhesive composition (3) was prepared in the same manner as in “Preparation of adhesive composition (1)” above except that the type of filler was changed to the type shown in Table 2 below.

The filler 3 is composed of aluminum hydroxide (B303, manufactured by Nippon Light Metal Company, Ltd., polygonal, volume-average particle size: 23 μm) and has a particle size distribution (D₉₀/D₁₀), as measured in the same manner as that of the filler 1, of 18.5.

### <Preparation of Adhesive Composition (4)>

An adhesive composition (4) was prepared in the same manner as in “Preparation of adhesive composition (1)” above except that the type of filler was changed to the type shown in Table 2 below.

The filler 4 is composed of aluminum hydroxide (BE033, manufactured by Nippon Light Metal Company, Ltd., polygonal, volume-average particle size: 3 μm) and has a particle size distribution (D₉₀/D₁₀), as measured in the same manner as that of the filler 1, of 5.8.

### <Preparation of Adhesive Composition (5)>

An adhesive composition (5) was prepared in the same manner as in “Preparation of adhesive composition (1)” above except that the amount of filler was changed to the amount shown in Table 2 below.

### <Preparation of Adhesive Composition (6)>

An adhesive composition (6) was prepared in the same manner as in “Preparation of adhesive composition (1)” above except that the amount of filler was changed to the amount shown in Table 2 below.

### <Preparation of Adhesive Composition (7)>

In a reaction vessel equipped with a stirrer, a reflux condenser, a nitrogen inlet tube, a thermometer, and a dropping funnel, 97.97 parts by weight of n-butyl acrylate, 2.0 parts by weight of acrylic acid, 0.03 parts by weight of 4-hydroxybutyl acrylate, and 0.1 parts by weight of 2,2′-azobisisobutyronitrile serving as a polymerization initiator were dissolved in a solvent composed of 100 parts by weight of ethyl acetate, and allowed to undergo polymerization at 70° C. for 12 hours to obtain an acrylic copolymer solution (2) having a weight-average molecular weight of 2,000,000 (in terms of polystyrene). Next, 25 parts by weight of glycerol ester of a disproportionated rosin (SUPER ESTER A100, manufactured by Arakawa Chemical Industries, Ltd.), 5 parts by weight of pentaerythritol ester of a polymerized rosin (PENSEL D135, manufactured by Arakawa Chemical Industries, Ltd.), and 20 parts by weight of a styrene petroleum resin (FTR (registered trademark) 6100, manufactured by Mitsui Chemicals, Inc.) were added to 100 parts by weight of the acrylic copolymer solution (2), and ethyl acetate was added and homogeneously mixed to obtain an adhesive solution (2) with a solids content of 31 wt %.

Next, to the adhesive resin solution (2) obtained, the filler 1 (aluminum hydroxide, BW153, manufactured by Nippon Light Metal Company, Ltd., volume-average particle size: 18 μm, particle size distribution (D₉₀/D₁₀): 12.3) in an amount of 30 parts by weight relative to 100 parts by weight of the solids content of the adhesive resin solution (2) was added, and then an isocyanate crosslinking agent (CORONATE L-45, manufactured by Nippon Polyurethane Industry Co., Ltd., non-volatile content: 45 wt %) in an amount of 1.3 parts by weight relative to 100 parts by weight of the adhesive resin solution (2) was added and homogeneously mixed under stirring to obtain an adhesive composition (7).

### <Preparation of Adhesive Composition (8)>

An adhesive composition (12) was prepared in the same manner as in “Preparation of adhesive composition (1)” above except that the type of filler was changed to the type shown in Table 2 below.

The filler 5 is composed of silicone particles (EMP-601, manufactured by Shin-Etsu Chemical Co., Ltd., spherical, volume-average particle size: 12 μm) and has a particle size distribution (D₉₀/D₁₀), as measured in the same manner as that of the filler 1, of 4.4.

### <Preparation of Adhesive Composition (9)>

An adhesive composition (9) was prepared in the same manner as in “Preparation of adhesive composition (1)” above except that no fillers were added.

### <Preparation of Adhesive Composition (10)>

An adhesive composition (10) was prepared in the same manner as in “Preparation of adhesive composition (1)” above except that the amount of filler was changed to the amount shown in Table 3 below.

### <Preparation of Adhesive Composition (11)>

An adhesive composition (11) was prepared in the same manner as in “Preparation of adhesive composition (1)” above except that the amount of filler was changed to the amount shown in Table 3 below.

### <Preparation of Adhesive Composition (12)>

An adhesive composition (12) was prepared in the same manner as in “Preparation of adhesive composition (1)” above except that the amount of filler was changed to the amount shown in Table 3 below.

### Example 1: Production of Adhesive Sheet (1)

Using an applicator, the adhesive composition (1) was applied to a release liner (FILMBYNA 75E-0010GT, manufactured by FUJIMORI KOGYO CO., LTD., hereinafter the same) so as to have a dry thickness of 50 μm and dried at 80° C. for 3 minutes, thereby forming an adhesive layer.

Next, toluene was added to the resin composition (1) and homogeneously stirred, and using an applicator, the resulting mixture was applied to a release liner so as to have a dry thickness of 50 μm and dried at 60° C. for 5 minutes, thereby forming a substrate layer.

After the release liner on the substrate layer was peeled off, the adhesive layer from which the release liner was peeled off was bonded to both surfaces of the substrate layer, and the stacked structure formed of the substrate layer and the adhesive layer was laminated under a pressure of 0.2 MPa, thereby producing an adhesive sheet (1).

### Example 2: Production of Adhesive Sheet (2)

An adhesive sheet (2) was produced in the same manner as the adhesive sheet (1) of Example 1 except that the thickness of the substrate layer and the thickness of the adhesive layer were changed as shown in Table 1.

### Example 3: Production of Adhesive Sheet (3)

An adhesive sheet (3) was produced in the same manner as the adhesive sheet (1) of Example 1 except that the thickness of the substrate layer, the type of adhesive composition, and the thickness of the adhesive layer were changed as shown in Table 1.

### Example 4: Production of Adhesive Sheet (4)

An adhesive sheet (4) was produced in the same manner as the adhesive sheet (1) of Example 1 except that the type of resin composition for the substrate layer, the thickness of the substrate layer, and the thickness of the adhesive layer were changed as shown in Table 1.

### Example 5: Production of Adhesive Sheet (5)

An adhesive sheet (5) was produced in the same manner as the adhesive sheet (1) of Example 1 except that the type of resin composition for the substrate layer was changed as shown in Table 1.

### Example 6: Production of Adhesive Sheet (6)

An adhesive sheet (6) was produced in the same manner as the adhesive sheet (1) of Example 1 except that the thickness of the substrate layer, the type of adhesive composition, and the thickness of the adhesive layer were changed as shown in Table 2.

### Example 7: Production of Adhesive Sheet (7)

An adhesive sheet (7) was produced in the same manner as the adhesive sheet (1) of Example 1 except that the type of adhesive composition was changed as shown in Table 2.

### Example 8: Production of Adhesive Sheet (8)

An adhesive sheet (8) was produced in the same manner as the adhesive sheet (1) of Example 1 except that the type of adhesive composition and the thickness of the adhesive layer were changed as shown in Table 2.

### Example 9: Production of Adhesive Sheet (9)

An adhesive sheet (9) was produced in the same manner as the adhesive sheet (1) of Example 1 except that the type of adhesive composition and the thickness of the adhesive layer were changed as shown in Table 2.

### Example 10: Production of adhesive sheet (10)

An adhesive sheet (10) was produced in the same manner as the adhesive sheet (1) of Example 1 except that the type of adhesive composition and the thickness of the adhesive layer were changed as shown in Table 2.

### Example 11: Production of adhesive sheet (11)

An adhesive sheet (11) was produced in the same manner as the adhesive sheet (1) of Example 1 except that the type of adhesive composition and the thickness of the adhesive sheet were changed as shown in Table 2.

### Comparative Example 1: Production of Adhesive Sheet (12)

Using an applicator, the adhesive composition (1) was applied to a release liner so as to have a dry thickness of 25 μm and dried at 80° C. for 3 minutes, thereby forming an adhesive layer.

The adhesive layer from which the release liner was peeled off was bonded to both surfaces of a PET film (the resin composition (5) serving as a substrate layer, and the stacked structure formed of the substrate layer and the adhesive layer was laminated under a pressure of 0.2 MPa, thereby producing an adhesive sheet (12).

### Comparative Example 2: Production of Adhesive Sheet (13)

An adhesive sheet (13) was produced in the same manner as the adhesive sheet (1) of Example 1 except that the type of resin composition for the substrate layer, the thickness of the substrate layer, and the thickness of the adhesive layer were changed as shown in Table 3.

### Comparative Example 3: Production of Adhesive Sheet (14)

An adhesive sheet (14) was produced in the same manner as the adhesive sheet (1) of Example 1 except that the thickness of the substrate layer, the type of adhesive composition, and the thickness of the adhesive layer were changed as shown in Table 3.

### Comparative Example 4: Production of Adhesive Sheet (15)

An adhesive sheet (15) was produced in the same manner as the adhesive sheet (1) of Example 1 except that the thickness of the substrate layer, the type of adhesive composition, and the thickness of the adhesive layer were changed as shown in Table 3.

### Comparative Example 5: Production of Adhesive Sheet (16)

An adhesive sheet (16) was produced in the same manner as the adhesive sheet (1) of Example 1 except that the thickness of the substrate layer, the type of adhesive composition, and the thickness of the adhesive layer were changed as shown in Table 3.

### Comparative Example 5: Production of Adhesive Sheet (17)

An adhesive sheet (17) was produced in the same manner as the adhesive sheet (1) of Example 1 except that the type of adhesive composition and the thickness of the adhesive layer were changed as shown in Table 3.

The stress at 25% elongation, stress at break, and elongation at break of the adhesive sheets (1) to (17) of Examples 1 to 11 and Comparative Examples 1 to 6, and the substrate layers and the adhesive layers thereof were measured by the following methods. For the adhesive sheets (1) to (17) of Examples 1 to 11 and Comparative Examples 1 to 6, the hardness (Shore A) was also measured by the following method. For the adhesive layers of the adhesive sheets (1) to (17) of Examples 1 to 11 and Comparative Examples 1 to 6, the volume ratio of the fillers was also measured by the following method.

### <Measurement of Stress at 25% Elongation, Stress at Break, and Elongation at Break of Adhesive Sheet or Substrate Layer>>

Each adhesive sheet or each substrate layer was punched into a dumbbell shape with a gauge length of 20 mm and a width of 6 mm and stretched in the longitudinal direction at a tensile speed of 500 mm/min using a Tensilon tensile tester (model: RTF-1210, manufactured by A&D Company, Limited) in a measurement atmosphere of 23° C. and 50% RH. In this manner, the stress at 25% elongation, stress at break, and elongation at break of each adhesive sheet or each substrate layer were measured. The results are shown in Tables 1 to 3 below.

### <Measurement of Stress at 25% Elongation, Stress at Break, and Elongation at Break of Adhesive Layer>>

Each adhesive layer was punched into a dumbbell shape with a gauge length of 20 mm and a width of 10 mm and stretched in the longitudinal direction at a tensile speed of 300 mm/min using a Tensilon tensile tester (model: RTF-1210, manufactured by A&D Company, Limited) in a measurement atmosphere of 23° C. and 50% RH. In this manner, the stress at 25% elongation, stress at break, and elongation at break of each adhesive layer were measured. The results are shown in Tables 1 to 3 below.

### <<Measurement of Hardness>>

The Shore A hardness of each adhesive sheet was measured in accordance with JIS K 6253 using a durometer (spring-type rubber hardness tester) (model: GS-719G, manufactured by Teclock Corporation).

### <<Measurement of Volume Ratio of Filler Particles to Adhesive Layer>>

The volume ratio of each filler to each adhesive layer was calculated by formulae (1) to (3) below.

Weight A (g) of adhesive resin*¹/density A (g/cm³) of adhesive resin*¹=volume A (cm³) adhesive resin*¹ formula (1)

Weight B (g) of filler particles/density B (g/cm³) of filler particles=volume B (cm³) of filler particles formula (2)

Volume B (cm³) of filler particles/(volume A (cm³) of adhesive resin*¹+volume B (cm³) of filler particles)×100=volume ratio (%) of filler particles formula (3)

The calculations were performed assuming that the density A of the adhesive resins was 1.2 g/cm³, and for the density B of the filler particles, the density of aluminum hydroxide was 2.42 g/cm³, the density of nickel was 8.90 g/cm³, and the density of silicone particles was 0.98 g/cm³.

The removability (in peeling by vertical stretching), impact resistance, 180° peel adhesive strength, shear adhesive strength, and cleavage adhesive strength of the adhesive sheets (1) to (17) of Examples 1 to 11 and Comparative Examples 1 to 6 were tested and evaluated by the following methods. The evaluation results are shown in Tables 1 to 3 below.

### <<Evaluation of Removability (in Peeling by Vertical Stretching)>>

Each adhesive sheet was cut to a length of 60 mm and a width of 10 mm. With a portion 10 mm long and 10 mm wide of the cut adhesive sheet being protruded to serve as a grip, a clean and smooth-surfaced aluminum plate (150 mm long, 50 mm wide, and 2 mm thick, alloy number: A1050) was attached to one surface of the adhesive sheet in an atmosphere at 23° C. and 50% RH. Next, a clean and smooth-surfaced acrylic plate (150 mm long, 50 mm wide, and 2 mm thick, Acrylite L, tone: colorless, manufactured by Mitsubishi Rayon Co., Ltd.) was attached to the surface of the adhesive sheet opposite to the surface to which the aluminum plate was attached. The stacked structure formed of the aluminum plate, the adhesive sheet, and the acrylic plate was pressed and bonded by rolling a roller back and forth once under a load of 5 kg and then allowed to stand in an atmosphere at 23° C. and 50% RH for 3 days to prepare a test piece.

In an atmosphere at 23° C. and 50% RH, the grip portion of the adhesive sheet of the test piece was stretched in the 90° direction (vertical direction) with respect to the attached surface of the adhesive sheet at a tensile speed of 300 mm/min using a Tensilon tensile tester (model: RTF-1210, manufactured by A&D Company, Limited). In this test, the occurrence of breakage of the adhesive sheet and the degree of adhesive composition residues left on the adherend (at least one of the aluminum plate and the acrylic plate) after peeling off of the adhesive sheet were visually checked.

The test according to the above procedure was performed three times, and the removability (in peeling by vertical stretching) was evaluated according to the following evaluation criteria. The results are shown in Tables 1 to 3 below.

### [Evaluation Criteria]

⊙: Breakage of the adhesive sheet occurred zero times among the three times.

◯: Breakage of the adhesive sheet occurred once among the three times, and/or the area of adhesive composition residues left on the adherend was less than 1/5 of the initial attachment area.

Δ: Breakage of the adhesive sheet occurred once among the three times, and the adhesive sheet was not stretched and the area of adhesive sheet residues left on the adherend was ⅘ or more of the initial attachment area.

x: Breakage of the adhesive sheet occurred twice or more among the three times, and/or the adhesive sheet was not stretched and could not be removed.

⊙ and ◯ are practically acceptable.

### <<Evaluation of Impact Resistance>>

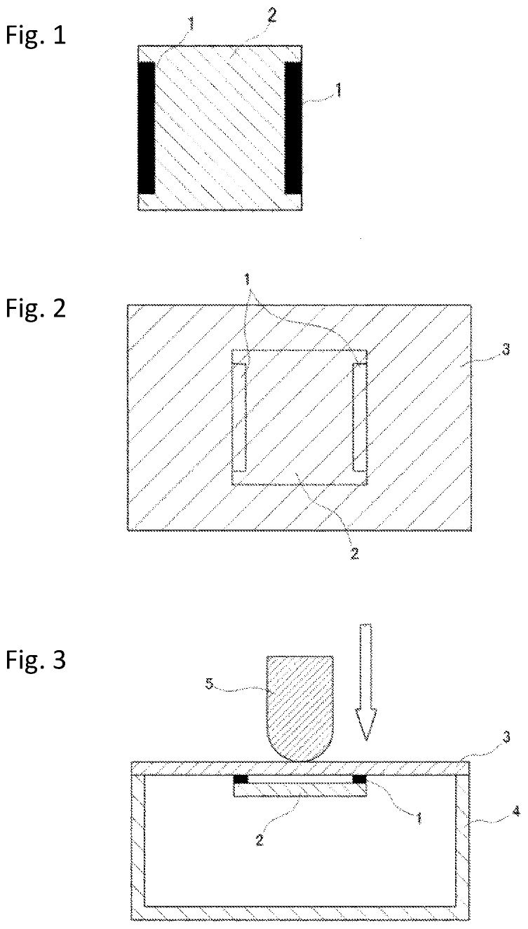

Each adhesive sheet was cut to prepare two pieces having a length of 20 mm and a width of 5 mm. As illustrated in FIG. 1, the two pieces of the adhesive sheet 1 were attached to an acrylic plate (50 mm long, 50 mm wide, and 2 mm thick, Acrylite L, tone: colorless, manufactured by Mitsubishi Rayon Co., Ltd.) 2 in parallel with a 40 mm space therebetween. Next, as illustrated in FIG. 2, the acrylic plate 2 to which the adhesive sheet 1 was attached was attached to a central part of an ABS plate (150 mm long, 100 mm wide, and 2 mm thick, Toughace R, manufactured by Sumitomo Bakelite Co., Ltd., hue: natural, no embossing) 3. The stacked structure formed of the acrylic plate 2, the adhesive sheet 1, and the ABS plate 3 was pressed and bonded by rolling a roller back and forth once under a load of 2 kg and then allowed to stand in an atmosphere at 40° C. and 50% RH for 24 hours to prepare a test piece.

As illustrated in FIG. 3, a U-shaped measurement stage (150 mm long, 100 mm wide, 45 mm high, and 5 mm thick, made of aluminum) 4 was placed on a base of a DuPont impact tester (manufactured by Tester Sangyo Co., Ltd.), and the test piece was placed on the U-shaped measurement stage with the acrylic plate 2 of the test piece facing downward (FIG. 3). In an atmosphere at 23° C. and 50% RH, a stainless steel impact core (diameter: 25 mm, weight: 300 g) 5 was dropped from the ABS plate 3 side onto the center of the ABS plate 3. In this test, the height from which the impact core 5 was dropped was changed from 10 cm in increments of 10 cm, and from each height, the impact core 5 was dropped five times at intervals of 10 seconds. The height at which peeling or fracture of the adhesive sheet of the test piece was observed was determined, and the impact resistance was evaluated according to the following evaluation criteria. The results are shown in Tables 1 to 3 below.

### [Evaluation Criteria]

⊙: Neither peeling nor fracture of the adhesive sheet occurred when the impact core 5 was dropped from a height of 60 cm or more.

◯: Neither peeling nor fracture of the adhesive sheet occurred when the impact core 5 was dropped from a height of 30 cm to 50 cm.

Δ: Peeling or fracture of the adhesive sheet occurred when the impact core 5 was dropped from a height of 10 cm or more and less than 30 cm.

x: Peeling or fracture of the adhesive sheet occurred when the height of the impact core 5 was 10 cm.

⊙ and ◯ are practically acceptable.

### <<Evaluation of 180° Peel Adhesive Strength>>

The 180° peel adhesive strength was measured in accordance with JIS Z 0237. Specifically, each adhesive sheet was cut to a length of 150 mm and a width of 20 mm, and one surface of the adhesive sheet was backed with a PET film having a thickness of 25 μm. Next, the other surface of the adhesive sheet was attached to a stainless steel plate (100 mm long, 30 mm wide, and 3 mm thick) in an atmosphere at 23° C. and 50% RH. The stacked structure formed of the adhesive sheet and the stainless steel plate was pressed and bonded by rolling a roller back and forth once under a load of 2 kg and then allowed to stand for one hour in an atmosphere at 23° C. and 50% RH to prepare a test piece.

In an atmosphere at 23° C. and 50% RH, the adhesive sheet of the test piece was stretched in the 180° direction (horizontal direction) at a tensile speed of 300 mm/min using a Tensilon tensile tester (model: RTF-1210, manufactured by A&D Company, Limited) to determine the 180° peel adhesive strength of the adhesive sheet.

### <<Evaluation of Shear Adhesive Strength>>

Each adhesive sheet was cut to a length of 20 mm and a width of 20 mm. In an atmosphere at 23° C. and 50% RH, a clean stainless steel plate A (100 mm long, 30 mm wide, and 3 mm thick) hairline-polished with waterproof abrasive paper (No. 360) was attached to one surface of the adhesive sheet such that the attachment area was 20 mm×20 mm. Next, a clean and smooth-surfaced stainless steel plate B (100 mm long, 30 mm wide, and 3 mm thick) hairline-polished with waterproof abrasive paper (No. 360) was attached to the surface of the adhesive sheet opposite to the surface to which the stainless steel plate A was attached. The stacked structure formed of the stainless steel plate A, the adhesive sheet, and the stainless steel plate B was pressed and bonded by rolling a roller back and forth once under a load of 5 kg and then allowed to stand for 24 hours in an atmosphere at 23° C. and 50% RH to prepare a test piece.

In an atmosphere at 23° C. and 50% RH, the stainless steel plate B constituting the test piece was stretched in the shear direction of the adhesive sheet at a tensile speed of 50 mm/min using a Tensilon tensile tester (model: RTF-1210, manufactured by A&D Company, Limited) with the stainless steel plate A constituting the test piece being fixed, to thereby determine the shear adhesive strength. The results are shown in Tables 1 to 3 below.

### <<Evaluation of Cleavage Adhesive Strength>>

Each adhesive sheet was cut to a length of 20 mm and a width of 20 mm. In an atmosphere at 23° C. and 50% RH, a surface of a clean and smooth-surfaced aluminum plate (alloy number: A1050, 50 mm long, 40 mm wide, and 3 mm thick) was attached to one surface of the adhesive sheet such that the attachment area was 20 mm×20 mm. Next, a clean and smooth-surfaced aluminum plate (alloy number: A1050, 50 mm long, 40 mm wide, and 3 mm thick) was attached to the surface of the adhesive sheet opposite to the surface to which the aluminum plate was attached. The stacked structure formed of the two aluminum plates and the adhesive sheet was pressed and bonded by rolling a roller back and forth once under a load of 5 kg and then allowed to stand for 24 hours in an atmosphere at 23° C. and 50% RH to prepare a test piece.

In an atmosphere at 23° C. and 50% RH, the aluminum plate B constituting the test piece was stretched in the cleavage direction (thickness direction) of the adhesive sheet at a tensile speed of 50 mm/min using a Tensilon tensile tester (model: RTF-1210, manufactured by A&D Company, Limited) with the aluminum plate A constituting the test piece being fixed, to thereby determine the cleavage adhesive strength. The results are shown in Tables 1 to 3 below.

TABLE 1

| | Example 1 | Example 2 | Example 3 | Example 4 | Example 5 |
|---|---|---|---|---|---|
| | Adhesive sheet | Adhesive sheet | Adhesive sheet | Adhesive sheet | Adhesive sheet |
| | (1) | (2) | (3) | (4) | (5) |
| Substrate Layer | | | | | |
| Resin composition | Resin | Resin | Resin | Resin | Resin |
| | composition (1) | composition (1) | composition (1) | composition (2) | composition (3) |
| | (SIS) | (SIS) | (SIS) | (polyurethane) | (SIS) |
| Thickness [μm] | 50 | 100 | 100 | 100 | 50 |
| Stress at 25% elongation [Mpa] | 1.03 | 0.90 | 0.90 | 1.80 | 0.31 |
| Stress at break (MD) [Mpa] | 18.60 | 8.35 | 8.35 | 33.00 | 10.50 |
| Elongation at break (MD) [%] | 1150.0 | 970.00 | 970.00 | 720.0 | 1250.0 |
| Adhesive layer | | | | | |
| Adhesive composition | Adhesive | Adhesive | Adhesive | Adhesive | Adhesvie |
| | composition (1) | composition (1) | composition (2) | composition (1) | composition (1) |
| Adhesive resin | Adhesive resin | Adhesive resin | Adhesive resin | Adhesive resin | Adhesive resin |
| | (1) | (1) | (1) | (1) | (1) |
| Filler particles | | | | | |
| Type | Filler 1 | Filler 1 | Filler 2 | Filler 1 | Filler 1 |
| Amount (*1) | 30 | 30 | 50 | 30 | 30 |
| Average particle size [μm] | 18 | 18 | 11.9 | 18 | 18 |
| Particle size distribution (D₉₀/D₁₀) | 12.3 | 12.3 | 4.2 | 12.3 | 12.3 |
| Volume ratio [%] | 13 | 13 | 6 | 13 | 13 |
| Thickness [μm] | 50 | 25 | 25 | 25 | 50 |
| Stress at 25% elongation [Mpa] | 0.06 | 0.06 | 0.08 | 0.06 | 0.06 |
| Stress at break (MD) [Mpa] | 1.68 | 1.68 | 1.85 | 1.68 | 1.68 |
| Elongation at break (MD) [%] | 700 | 1100 | 770 | 1100 | 700 |
| Ratio [volume-average particle size of filler | 36/100 | 72/100 | 47.6/100 | 72/100 | 36/100 |
| particles/average thickness of adhesive | | | | | |
| layer] | | | | | |
| Adhesive sheet | | | | | |
| Thickness [μm] | 150 | 150 | 150 | 150 | 150 |
| Hardness (Shore A) | 73 | 80 | 79 | 81 | 64 |
| Stress at 25% elongation [Mpa] | 0.41 | 0.58 | 0.51 | 1.30 | 0.19 |
| Stress at break (MD) [Mpa] | 9.50 | 10.50 | 10.60 | 36.00 | 5.90 |
| Elongation at break (MD) [%] | 1250.00 | 1775.00 | 1710.00 | 760.00 | 1200.00 |
| Evaluation | | | | | |
| Removability (in peeling by vertical | ⊙ | ⊙ | ⊙ | ⊙ | ⊙ |
| stretching) | | | | | |
| Impact resistance | ⊙ | ◯ | ⊙ | ◯ | ⊙ |
| 180° peel adhesive strength [N/20 mm] | 15.5 | 10 | 10 | 5 | 14 |
| Shear adhesive strength [N/4 cm²] | 500 | 360 | 365 | 480 | 410 |
| Cleavage adhesive strength [N/4 cm²] | 405 | 210 | 205 | 205 | 200 |

*1: The amount of the filler particles represents the amount (parts by weight) of the filler particles relative to 100 parts by weight of the adhesive resin (1) or the adhesive resin (2).

TABLE 2

| | Example 6 | Example 7 | Example 8 | Example 9 | Example 10 | Example 11 |
|---|---|---|---|---|---|---|
| | Adhesive sheet | Adhesive sheet | Adhesive sheet | Adhesive sheet | Adhesive sheet | Adhesive sheet |
| | (6) | (7) | (8) | (9) | (10) | (11) |
| Substrate Layer | | | | | | |
| Resin composition | Resin | Resin | Resin | Resin | Resin | Resin |
| | composition (1) | composition (1) | composition (1) | composition (1) | composition (1) | composition (1) |
| | (SIS) | (SIS) | (SIS) | (SIS) | (SIS) | (SIS) |
| Thickness [μm] | 100 | 50 | 50 | 50 | 50 | 50 |
| Stress at 25% elongation [Mpa] | 0.90 | 1.03 | 1.03 | 1.03 | 1.03 | 1.03 |
| Stress at break (MD) [Mpa] | 8.35 | 18.60 | 18.60 | 18.60 | 18.60 | 18.60 |
| Elongation at break (MD) [%] | 970.00 | 1150.0 | 1150.0 | 1150.0 | 1150.0 | 1150.0 |
| Adhesive layer | | | | | | |
| Adhesive composition | Adhesive | Adhesive | Adhesive | Adhesive | Adhesive | Adhesive |
| | composition (3) | composition (4) | composition (5) | composition (6) | composition (7) | composition (8) |
| Adhesive resin | Adhesive resin | Adhesive resin | Adhesive resin | Adhesive resin | Adhesive resin | Adhesive resin |
| | (1) | (1) | (1) | (1) | (2) | (1) |
| Filler particles | | | | | | |
| Type | Filler 3 | Filler 4 | Filler 1 | Filler 1 | Filler 1 | Filler 5 |
| Amount (*1) | 30 | 30 | 50 | 15 | 30 | 30 |
| Average particle size [μm] | 23 | 3 | 18 | 18 | 18 | 12 |
| Particle size distribution (D₉₀/D₁₀) | 18.5 | 5.8 | 12.3 | 12.3 | 12.3 | 4.4 |
| Volume ratio [%] | 13 | 13 | 19 | 7 | 13 | 27 |
| Thickness [μm] | 25 | 50 | 25 | 25 | 25 | 50 |
| Stress at 25% elongation [Mpa] | 0.07 | 0.09 | 0.10 | 0.08 | 0.07 | 0.06 |
| Stress at break (MD) [Mpa] | 1.35 | 1.86 | 2.01 | 1.49 | 1.05 | 1.54 |
| Elongation at break (MD) [%] | 850.00 | 900.00 | 700.00 | 00.00 | 650 | 780 |
| Ratio [volume-average particle size of filler | 92/100 | 6/100 | 72/100 | 72/100 | 72/100 | 24/100 |
| particles/average thickness of adhesive | | | | | | |
| layer] | | | | | | |
| Adhesive sheet | | | | | | |
| Thickness [μm] | 150 | 150 | 100 | 100 | 100 | 100 |
| Hardness (Shore A) | 67 | 70 | 71 | 78 | 76 | 60 |
| Stress at 25% elongation [Mpa] | 0.59 | 0.42 | 0.50 | 0.63 | 0.36 | 0.39 |
| Stress at break (MD) [Mpa] | 15.20 | 9.80 | 8.50 | 8.40 | 12.50 | 10.11 |
| Elongation at break (MD) [%] | 1550 | 1400 | 1200 | 1100 | 1450 | 1250 |
| Evaluation | | | | | | |
| Removability (in peeling by vertical | ⊙ | ◯ | ⊙ | ⊙ | ⊙ | ⊙ |
| stretching) | | | | | | |
| Impact resistance | ◯ | ◯ | ◯ | ◯ | ◯ | ⊙ |
| 180° peel adhesive strength [N/20 mm] | 5 | 16.5 | 9.5 | 10.5 | 5 | 16 |
| Shear adhesive strength [N/4 cm²] | 260 | 550 | 260 | 250 | 305 | 520 |
| Cleavage adhesive strength [N/4 cm²] | 150 | 375 | 170 | 200 | 160 | 450 |

*1: The amount of the filler particles represents the amount (parts by weight) of the filler particles relative to 100 parts by weight of the adhesive resin (1) or the adhesive resin (2).

TABLE 3

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| | Adhesive sheet | Adhesive sheet | Adhesive sheet | Adhesive sheet | Adhesive sheet | Adhesive sheet |
| | (12) | (13) | (14) | (15) | (16) | (17) |
| Substrate Layer | | | | | | |
| Resin composition | Resin | Resin | Resin | Resin | Resin | Resin |
| | composition (5) | composition (4) | composition (1) | composition (1) | composition (1) | composition (1) |
| | (PET film) | (SIS) | (SIS) | (SIS) | (SIS) | (SIS) |
| Thickness [μm] | 100 | 100 | 100 | 100 | 100 | 50 |
| Stress at 25% elongation [Mpa] | 126.60 | 0.18 | 0.90 | 0.90 | 0.90 | 1.03 |
| Stress at break (MD) [Mpa] | 180.80 | 1.35 | 8.35 | 8.35 | 8.35 | 18.60 |
| Elongation at break (MD) [%] | 181.40 | 1350.0 | 970.00 | 970.00 | 970.00 | 1150.0 |
| Adhesive layer | | | | | | |
| Adhesive composition | Adhesive | Adhesive | Adhesive | Adhesive | Adhesive | Adhesive |
| | composition (1) | composition (1) | composition (9) | composition (10) | composition (11) | composition (12) |
| Adhesive resin | Adhesive resin | Adhesive resin | Adhesive resin | Adhesive resin | Adhesive resin | Adhesive resin |
| | (1) | (1) | (1) | (1) | (1) | (1) |
| Filler particles | | | | | | |
| Type | Filler 1 | Filler 1 | — | Filler 1 | Filler 1 | Filler 1 |
| Amount (*1) | 30 | 30 | — | 5 | 200 | 100 |
| Average particle size [μm] | 18 | 18 | — | 18 | 18 | 18 |
| Particle size distribution (D₉₀/D₁₀) | 12.3 | 12.3 | — | 12.3 | 12.3 | 12.3 |
| Volume ratio [%] | 13 | 13 | — | 2 | 50 | 33 |
| Thickness [μm] | 25 | 25 | 25 | 25 | 25 | 25 |
| Stress at 25% elongation [Mpa] | 0.06 | 0.06 | 0.03 | 0.07 | 0.48 | 0.11 |
| Stress at break (MD) [Mpa] | 1.68 | 1.68 | 1.23 | 0.98 | 1.3 | 2.21 |
| Elongation at break (MD) [%] | 1100 | 1100 | 1050.00 | 1100 | 400 | 700.00 |
| Ratio [volume-average particle size of filler | 72/100 | 72/100 | — | 72/100 | 72/100 | 72/100 |
| particles/average thickness of adhesive | | | | | | |
| layer] | | | | | | |
| Adhesive sheet | | | | | | |
| Thickness [μm] | 150 | 150 | 150 | 150 | 150 | 100 |
| Hardness (Shore A) | 92 | 63 | 81 | 78 | 78 | 70 |
| Stress at 25% elongation [Mpa] | 82.44 | 0.14 | 0.65 | 0.64 | 0.72 | 0.53 |
| Stress at break (MD) [Mpa] | 114.80 | 2.00 | 13.50 | 8.60 | 10.50 | 8.20 |
| Elongation at break (MD) [%] | 125.00 | 1500.00 | 1250.00 | 1200.00 | 1200.00 | 1150 |
| Evaluation | | | | | | |
| Removability (in peeling by vertical | X | X | X | X | Δ | Δ |
| stretching) | | | | | | |
| Impact resistance | X | ◯ | ⊙ | ⊙ | X | X |
| 180° peel adhesive strength [N/20 mm] | 3 | 19.5 | 13 | 12 | 4 | 4.5 |
| Shear adhesive strength [N/4 cm²] | 305 | 280 | 355 | 345 | 10 | 255 |
| Cleavage adhesive strength [N/4 cm²] | 10 | 135 | 275 | 260 | 20 | 135 |

*1: The amount of the filler particles represents the amount (parts by weight) of the filler particles relative to 100 parts by weight of the adhesive resin (1) or the adhesive resin (2).

The results in Tables 1 to 3 above show that the adhesive sheets of Examples 1 to 11 can each be easily peeled off by stretching even if the direction of the stretching is the perpendicular direction with respect to an attached surface of an attached object, are each less likely to break even when the substrate of the adhesive sheet is thin, and are each excellent in impact resistance, shear adhesive strength, and cleavage adhesive strength.

In contrast, none of the adhesive sheets of Comparative Examples 1 to 6 could be successfully peeled off by stretching when the direction of the stretching was the perpendicular direction with respect to an attached surface of an attached object. Furthermore, in Comparative Examples 1, 5, and 6, the impact resistance was poor, and in Comparative Example 1, the shear adhesive strength was also poor.

Aspects of the present invention are, for example, as follows.

<1> An adhesive sheet includes an adhesive layer and a substrate layer.

The adhesive layer contains filler particles and an adhesive resin. The content of the filler particles in the adhesive layer is 10 parts by weight to 90 parts by weight relative to 100 parts by weight of the adhesive resin. The volume ratio of the filler particles to the adhesive layer is 4% to 40%.

The adhesive sheet has a stress at 25% elongation of 0.15 Mpa to 82 Mpa.

<2> In the adhesive sheet according to <1>, the filler particles have a particle size distribution (D₉₀/D₁₀) of 2.5 to 20.

<3> In the adhesive sheet according to <1> or <2>, the adhesive sheet has a Shore A hardness of 10 to 90.

<4> In the adhesive sheet according to any one of <1> to <3>, the adhesive sheet has an elongation at break (MD) of 1,000% to 1,800%.

### INDUSTRIAL APPLICABILITY

The adhesive sheet can be easily peeled off by stretching even if the direction of the stretching is the perpendicular direction with respect to an attached surface of an attached object, is less likely to break even when a substrate of the adhesive sheet is thin, and is excellent in impact resistance, shear adhesive strength, and cleavage adhesive strength. Thus, the adhesive sheet is suitable for use in, for example, part fixation in various industrial fields, e.g., fixation of metal sheets constituting relatively large electronic appliances such as flat-screen televisions, household electrical appliances, and OA appliances, fixation of exterior parts to housings, and fixation of exterior parts or rigid parts such as batteries to relatively small electronic appliances such as portable electronic terminals, cameras, and personal computers; temporary fixation of such parts; and labels displaying product information.

### REFERENCE SIGNS LIST

1 adhesive sheet
2 acrylic plate
3 ABS plate
4 U-shaped measurement stage
5 impact core

1. An adhesive sheet comprising an adhesive layer and a substrate layer,
wherein the adhesive layer contains filler particles and an adhesive resin, a content of the filler particles in the adhesive layer is 10 parts by weight to 90 parts by weight relative to 100 parts by weight of the adhesive resin, and a volume ratio of the filler particles to the adhesive layer is 4% to 40%, and
the adhesive sheet has a stress at 25% elongation of 0.15 Mpa to 82 Mpa.

2. The adhesive sheet according to claim 1, wherein the filler particles have a particle size distribution (D₉₀/D₁₀) of 2.5 to 20.

3. The adhesive sheet according to claim 1, wherein the adhesive sheet has a Shore A hardness of 10 to 90.

4. The adhesive sheet according to claim 1, wherein the adhesive sheet has an elongation at break (MD) of 1,000% to 1,800%.
